(19) United States
(12) Patent Application Publication
(10) Pub. No.: US 2016/0111100 A1
(43) Pub. Date: Apr. 21, 2016

(54) AUDIO SIGNAL ENCODER

(71) Applicant: Nokia Technologies Oy, Espoo (FI)

(72) Inventors: Anssi Sakari Ramo, Tampere (FI); Adriana Vasilache, Tampere (FI); Lasse Juhani Laaksonen, Tampere (FI)

(73) Assignee: Nokia Technologies Oy, Espoo (FI)

(21) Appl. No.: 14/893,604

(22) PCT Filed: May 28, 2013
(86) PCT No.: PCT/IB2013/054407

§ 371 Date: Nov. 24, 2015

(51) Int. Cl. G10L 19/008; H04S 1/00; G10L 19/032; G10L 19/00; G10L 19/005

(52) U.S. Cl. CPC G10L 19/008; G10L 19/0017; G10L 19/005; G10L 19/032; H04S 1/007; H04S 2420/03

(57) ABSTRACT

An apparatus comprising: a parameter determiner configured to determine for a frame of at least one audio signal a set of frame audio signal multi-channel parameters; a parameter selector configured to select for the frame a sub-set of the set of frame audio signal multi-channel parameters based on an error value associated with the sub-set of the set of frame audio signal multi-channel parameters; and parameter encoder configured to generate an encoded frame audio signal multi-channel parameter based on the selected sub-set of the set of frame audio signal multi-channel parameters.

### FIELD

The present application relates to a multichannel or stereo audio signal encoder, and in particular, but not exclusively to a multichannel or stereo audio signal encoder for use in portable apparatus.

### BACKGROUND

Audio signals, like speech or music, are encoded for example to enable efficient transmission or storage of the audio signals.

Audio encoders and decoders (also known as codecs) are used to represent audio based signals, such as music and ambient sounds (which in speech coding terms can be called background noise). These types of coders typically do not utilise a speech model for the coding process, rather they use processes for representing all types of audio signals, including speech. Speech encoders and decoders (codecs) can be considered to be audio codecs which are optimised for speech signals, and can operate at either a fixed or variable bit rate.

An audio codec can also be configured to operate with varying bit rates. At lower bit rates, such an audio codec may be optimized to work with speech signals at a coding rate equivalent to a pure speech codec. At higher bit rates, the audio codec may code any signal including music, background noise and speech, with higher quality and performance. A variable-rate audio codec can also implement an embedded scalable coding structure and bitstream, where additional bits (a specific amount of bits is often referred to as a layer) improve the coding upon lower rates, and where the bitstream of a higher rate may be truncated to obtain the bitstream of a lower rate coding. Such an audio codec may utilize a codec designed purely for speech signals as the core layer or lowest bit rate coding.

An audio codec is designed to maintain a high (perceptual) quality while improving the compression ratio. Thus instead of waveform matching coding it is common to employ various parametric schemes to lower the bit rate. For multichannel audio, such as stereo signals, it is common to use a larger amount of the available bit rate on a mono channel representation and encode the stereo or multichannel information exploiting a parametric approach which uses relatively fewer bits.

### SUMMARY

There is provided according to a first aspect a method comprising: determining for a frame of at least one audio signal a set of frame audio signal multi-channel parameters; selecting for the frame a sub-set of the set of frame audio signal multi-channel parameters based on an error value associated with the sub-set of the set of frame audio signal multi-channel parameters; and generating an encoded frame audio signal multi-channel parameter based on the selected sub-set of the set of frame audio signal multi-channel parameters.

The method may further comprise determining a coding bitrate for the frame of at least one audio signal; and wherein selecting for the frame a sub-set of the set of frame audio signal multi-channel parameters based on an error value associated with the sub-set of the set of frame audio signal multi-channel parameters may comprise selecting the sub-set of the set of frame audio signal multi-channel parameters further based on the coding bitrate for the frame of the at least one audio signal.

Determining for a frame of at least one audio signal a set of frame audio signal multi-channel parameters may comprise determining a set of differences between at least two channels of the at least one audio signal, wherein the set of differences may comprise two or more difference values, where each difference value may be associated with a sub-division of resources defining the frame.

Determining a set of differences between at least two channels of the at least one audio signal may comprise determining at least one of: at least one interaural time difference; and at least one interaural level difference.

The sub-division of resources defining the frame may comprise at least one of: sub-band frequencies; and time periods.

Selecting for the frame a subset of the set of frame audio signal multi-channel parameters based on an error value associated with the subset of the set of frame audio signal multi-channel parameters may comprise: determining at least one previous frame selected sub-set; determining a number of elements to be selected; generating at least two candidate subsets; generating a reconstructed set from a combination of the candidate sub-set and the at least one previous frame selected sub-set; generating an error value based on the reconstructed set and the set of frame audio signal multi-channel parameters; and selecting one of the at least two candidate sub-sets with the smallest absolute error value.

The method may further comprise: generating for the selected sub-set at least one parameter representing the selected subset; and generating an encoded at least one parameter representing the selected sub-set.

Generating for the selected sub-set at least one parameter representing the selected sub-set may comprise at least one of: generating a first parameter representing a first selected element in the selected subset; generating a distribution parameter representing the selection distribution of successive elements in the sub-set; and generating a length parameter representing the number of elements in the selected sub-set.

Generating an encoded frame audio signal multi-channel parameter based on the selected sub-set of the set of frame audio signal multi-channel parameters may comprise generating codebook indices for groups of the at least one frame audio signal multi-channel parameter using vector or scalar quantization codebooks.

Generating codebook indices for groups of the at least one frame audio signal multi-channel parameter using vector or scalar quantization codebooks may comprise: generating a encoding mapping with an associated index for the at least one frame audio signal multi-channel parameter dependent on a frequency distribution of mapping instances of the at least one frame audio signal multi-channel parameter; and encoding the encoding mapping dependent on the associated index.

Encoding the encoding mapping dependent on the associated index may comprises applying a Golomb-Rice encoding to the encoding mapping dependent on the associated index.

The method as described herein may further comprise: receiving at least two audio signal channels; determining a fewer number of channels audio signal from the at least two audio signal channels and the at least one frame audio signal multi-channel parameter; generating an encoded audio signal comprising the fewer number of channels; and combining the encoded audio signal and the encoded at least one frame audio signal multi-channel parameter.

According to a second aspect there is provided a method comprising: receiving within a period an encoded audio signal comprising at least one frame downmix audio signal and at least one multi-channel audio signal parameter signal comprising a sub-set of a set of frame audio signal multi-channel parameters; recovering any elements of the set of audio signal multi-channel parameters not present in the sub-set of frame audio signal multi-channel parameters; and generating for the frame at least two channel audio signals from the at least one frame downmix audio signal and the combination of a sub-set of a set of frame audio signal multi-channel parameters and recovered elements of the set of audio signal multi-channel parameters not present in the sub-set of frame audio signal multi-channel parameters.

The set of frame audio signal multi-channel parameters may comprise a set of differences between at least two channels of at least one audio signal, the set of differences may comprise two or more difference values, where each difference value may be associated with a sub-division of resources defining the frame.

The set of differences between at least two channels of the at least one audio signal may comprise at least one of: at least one interaural time difference; and at least one interaural level difference.

The sub-division of resources defining the frame may comprise at least one of: sub-band frequencies; and time periods.

The encoded audio signal may further comprise at least one parameter defining a sub-set of a set of frame audio signal multi-channel parameters; wherein recovering any elements of the set of audio signal multi-channel parameters not present in the sub-set of frame audio signal multi-channel parameters may comprise decoding the at least one parameter defining a sub-set of a set of frame audio signal multi-channel parameters to determine the sub-set elements to be recovered.

According to a third aspect there is provided an apparatus comprising: means for determining for a frame of at least one audio signal a set of frame audio signal multi-channel parameters; means for selecting for the frame a sub-set of the set of frame audio signal multi-channel parameters based on an error value associated with the sub-set of the set of frame audio signal multi-channel parameters; and means for generating an encoded frame audio signal multi-channel parameter based on the selected sub-set of the set of frame audio signal multi-channel parameters.

The apparatus may further comprise means for determining a coding bitrate for the frame of at least one audio signal; and wherein the means for selecting for the frame a sub-set of the set of frame audio signal multi-channel parameters based on an error value associated with the sub-set of the set of frame audio signal multi-channel parameters may comprise means for selecting the sub-set of the set of frame audio signal multi-channel parameters further based on the coding bitrate for the frame of the at least one audio signal.

The means for determining for a frame of at least one audio signal a set of frame audio signal multi-channel parameters may comprise means for determining a set of differences between at least two channels of the at least one audio signal, wherein the set of differences may comprise two or more difference values, where each difference value may be associated with a sub-division of resources defining the frame.

The means for determining a set of differences between at least two channels of the at least one audio signal may comprise at least one of: means for determining at least one interaural time difference; and means for determining at least one interaural level difference.

The sub-division of resources defining the frame may comprise at least one of: sub-band frequencies; and time periods.

The means for selecting for the frame a sub-set of the set of frame audio signal multi-channel parameters based on an error value associated with the sub-set of the set of frame audio signal multi-channel parameters may comprise: means for determining at least one previous frame selected sub-set; means for determining a number of elements to be selected; means for generating at least two candidate sub-sets; means for generating a reconstructed set from a combination of the candidate sub-set and the at least one previous frame selected sub-set; means for generating an error value based on the reconstructed set and the set of frame audio signal multi-channel parameters; and means for selecting one of the at least two candidate sub-sets with the smallest absolute error value.

The apparatus may further comprise: means for generating for the selected sub-set at least one parameter representing the selected sub-set; and means for generating an encoded at least one parameter representing the selected sub-set.

The means for generating for the selected sub-set at least one parameter representing the selected sub-set may comprise at least one of: means for generating a first parameter representing a first selected element in the selected sub-set; means for generating a distribution parameter representing the selection distribution of successive elements in the sub-set; and means for generating a length parameter representing the number of elements in the selected sub-set.

The means for generating an encoded frame audio signal multi-channel parameter based on the selected sub-set of the set of frame audio signal multi-channel parameters may comprise means for generating codebook indices for groups of the at least one frame audio signal multi-channel parameter using vector or scalar quantization codebooks.

The means for generating codebook indices for groups of the at least one frame audio signal multi-channel parameter using vector or scalar quantization codebooks may comprise: means for generating a first encoding mapping with an associated index for the at least one frame audio signal multi-channel parameter dependent on a frequency distribution of mapping instances of the at least one frame audio signal multi-channel parameter; and means for encoding the first encoding mapping dependent on the associated index.

The means for encoding the encoding mapping dependent on the associated index may comprise means for applying a Golomb-Rice encoding to the encoding mapping dependent on the associated index.

The apparatus may further comprise: means for receiving at least two audio signal channels; means for determining a fewer number of channels audio signal from the at least two audio signal channels and the at least one frame audio signal multi-channel parameter; means for generating an encoded audio signal comprising the fewer number of channels; and means for combining the encoded audio signal and the encoded at least one frame audio signal multi-channel parameter.

According to a fourth aspect there is provided an apparatus comprising: means for receiving within a period a encoded audio signal comprising at least one frame downmix audio signal and at least one multi-channel audio signal parameter signal comprising a sub-set of a set of frame audio signal multi-channel parameters; means for recovering any elements of the set of audio signal multi-channel parameters not present in the sub-set of frame audio signal multi-channel parameters; and means for generating for the frame at least two channel audio signals from the at least one frame downmix audio signal and the combination of the a sub-set of a set of frame audio signal multi-channel parameters and recovered elements of the set of audio signal multi-channel parameters not present in the sub-set of frame audio signal multi-channel parameters.

The set of frame audio signal multi-channel parameters may comprise a set of differences between at least two channels of at least one audio signal, wherein the set of differences may comprise two or more difference values, where each difference value may be associated with a sub-division of resources defining the frame.

The set of differences between at least two channels of the at least one audio signal may comprise at least one of: at least one interaural time difference; and at least one interaural level difference.

The sub-division of resources defining the frame may comprise at least one of: sub-band frequencies; and time periods.

The encoded audio signal may further comprise at least one parameter defining a sub-set of a set of frame audio signal multi-channel parameters; wherein the means for recovering any elements of the set of audio signal multi-channel parameters not present in the sub-set of frame audio signal multi-channel parameters may comprise decoding the at least one parameter defining a sub-set of a set of frame audio signal multi-channel parameters to determine the sub-set elements to be recovered.

According to a fifth aspect there is provided an apparatus comprising at least one processor and at least one memory including computer program code for one or more programs, the at least one memory and the computer program code configured to, with the at least one processor, cause the apparatus at least to: determine for a frame of at least one audio signal a set of frame audio signal multi-channel parameters; select for the frame a sub-set of the set of frame audio signal multi-channel parameters based on an error value associated with the sub-set of the set of frame audio signal multi-channel parameters; and generate an encoded frame audio signal multi-channel parameter based on the selected sub-set of the set of frame audio signal multi-channel parameters.

The apparatus may further be caused to determine a coding bitrate for the frame of at least one audio signal; and wherein selecting for the frame a sub-set of the set of frame audio signal multi-channel parameters based on an error value associated with the sub-set of the set of frame audio signal multi-channel parameters may cause the apparatus to select the sub-set of the set of frame audio signal multi-channel parameters further based on the coding bitrate for the frame of the at least one audio signal.

Determining for a frame of at least one audio signal a set of frame audio signal multi-channel parameters may cause the apparatus to determine a set of differences between at least two channels of the at least one audio signal, wherein the set of differences may comprise two or more difference values, where each difference value may be associated with a sub-division of resources defining the frame.

Determining a set of differences between at least two channels of the at least one audio signal may cause the apparatus to perform at least one of: determine at least one interaural time difference; and determine at least one interaural level difference.

The sub-division of resources defining the frame may comprise at least one of: sub-band frequencies; and time periods.

Selecting for the frame a sub-set of the set of frame audio signal multi-channel parameters based on an error value associated with the sub-set of the set of frame audio signal multi-channel parameters may cause the apparatus to: determine at least one previous frame selected sub-set; determine a number of elements to be selected; generate at least two candidate sub-sets: generate a reconstructed set from a combination of the candidate sub-set and the at least one previous frame selected subset; generate an error value based on the reconstructed set and the set of frame audio signal multi-channel parameters; and select one of the at least two candidate sub-sets with the smallest absolute error value.

The apparatus may further be caused to: generate for the selected subset at least one parameter representing the selected sub-set; and generate an encoded at least one parameter representing the selected subset.

Generating for the selected sub-set at least one parameter representing the selected sub-set may cause the apparatus to perform at least one of: generate a first parameter representing a first selected element in the selected sub-set; generate a distribution parameter representing the selection distribution of successive elements in the sub-set; and generate a length parameter representing the number of elements in the selected sub-set.

Generating an encoded frame audio signal multi-channel parameter based on the selected sub-set of the set of frame audio signal multi-channel parameters may cause the apparatus to generate codebook indices for groups of the at least one frame audio signal multi-channel parameter using vector or scalar quantization codebooks.

Generating codebook indices for groups of the at least one frame audio signal multi-channel parameter using vector or scalar quantization codebooks may cause the apparatus to: generate a encoding mapping with an associated index for the at least one frame audio signal multi-channel parameter dependent on a frequency distribution of mapping instances of the at least one frame audio signal multi-channel parameter; and encode the encoding mapping dependent on the associated index.

Encoding the encoding mapping dependent on the associated index may cause the apparatus to apply a Golomb-Rice encoding to the encoding mapping dependent on the associated index.

The apparatus may further be caused to: receive at least two audio signal channels; determine a fewer number of channels audio signal from the at least two audio signal channels and the at least one frame audio signal multi-channel parameter; generate an encoded audio signal comprising the fewer number of channels; and combine the encoded audio signal and the encoded at least one frame audio signal multi-channel parameter.

According to a sixth aspect there is provided an apparatus comprising at least one processor and at least one memory including computer program code for one or more programs, the at least one memory and the computer program code configured to, with the at least one processor, cause the apparatus at least to: receive within a period an encoded audio signal comprising at least one frame downmix audio signal and at least one multi-channel audio signal parameter signal comprising a sub-set of a set of frame audio signal multi-channel parameters; recover any elements of the set of audio signal multi-channel parameters not present in the sub-set of frame audio signal multi-channel parameters; and generate for the frame at least two channel audio signals from the at least one frame downmix audio signal and the combination of a sub-set of a set of frame audio signal multi-channel parameters and recovered elements of the set of audio signal multi-channel parameters not present in the sub-set of frame audio signal multi-channel parameters.

The set of frame audio signal multi-channel parameters may comprise a set of differences between at least two channels of at least one audio signal, wherein the set of differences may comprise two or more difference values, where each difference value may be associated with a sub-division of resources defining the frame.

The set of differences between at least two channels of the at least one audio signal may comprise at least one of: at least one interaural time difference; and at least one interaural level difference.

The sub-division of resources defining the frame may comprise at least one of: sub-band frequencies; and time periods.

The encoded audio signal may further comprise at least one parameter defining a sub-set of a set of frame audio signal multi-channel parameters; wherein recovering any elements of the set of audio signal multi-channel parameters not present in the sub-set of frame audio signal multi-channel parameters may cause the apparatus to decode the at least one parameter defining a sub-set of a set of frame audio signal multi-channel parameters to determine the sub-set elements to be recovered.

According to a seventh aspect there is provided an apparatus comprising: a parameter determiner configured to determine for a frame of at least one audio signal a set of frame audio signal multi-channel parameters; a parameter selector configured to select for the frame a sub-set of the set of frame audio signal multi-channel parameters based on an error value associated with the sub-set of the set of frame audio signal multi-channel parameters; and a parameter encoder configured to generate an encoded frame audio signal multi-channel parameter based on the selected sub-set of the set of frame audio signal multi-channel parameters.

The apparatus may further comprise a parameter selector determiner configured to determine a coding bitrate for the frame of at least one audio signal; and wherein the parameter selector is configured to select the sub-set of the set of frame audio signal multi-channel parameters further based on the coding bitrate for the frame of the at least one audio signal.

The parameter determiner may be configured to determine a set of differences between at least two channels of the at least one audio signal, wherein the set of differences may comprise two or more difference values, where each difference value may be associated with a sub-division of resources defining the frame.

The parameter determiner may comprise at least one of: an interaural time difference determiner configured to determine at least one interaural time difference; and an interaural level difference determiner configured to determine at least one interaural level difference.

The sub-division of resources defining the frame may comprise at least one of: sub-band frequencies; and time periods.

The parameter selector determiner may be configured to: determine at least one previous frame selected sub-set; determine a number of elements to be selected; generate at least two candidate sub-sets; generate a reconstructed set from a combination of the candidate sub-set and the at least one previous frame selected sub-set; generate an error value based on the reconstructed set and the set of frame audio signal multi-channel parameters; and select one of the at least two candidate sub-sets with the smallest absolute error value.

The parameter encoder may further comprise: a sub-set parameter generator configured to generate for the selected sub-set at least one parameter representing the selected sub-set; and a sub-set parameter encoder configured to generate an encoded at least one parameter representing the selected sub-set.

The sub-set parameter generator may be configured to generate at least one of: a first parameter representing a first selected element in the selected sub-set; a distribution parameter representing the selection distribution of successive elements in the sub-set; and a length parameter representing the number of elements in the selected sub-set.

The parameter encoder may be configured to generate at least one codebook index for groups of the at least one frame audio signal multi-channel parameter using vector or scalar quantization codebooks.

The parameter encoder may be configured to: generate a encoding mapping with an associated index for the at least one frame audio signal multi-channel parameter dependent on a frequency distribution of mapping instances of the at least one frame audio signal multi-channel parameter; and encode the encoding mapping dependent on the associated index.

The parameter encoder configured to encode the encoding mapping dependent on the associated index may be configured to apply a Golomb-Rice encoding to the encoding mapping dependent on the associated index.

The apparatus may further comprise: an input configured to receive at least two audio signal channels; a downmix channel generator configured to determine a fewer number of channels audio signal from the at least two audio signal channels and the at least one frame audio signal multi-channel parameter; a downmix channel encoder configured to generate an encoded audio signal comprising the fewer number of channels; and a combiner configured to combine the encoded audio signal and the encoded at least one frame audio signal multi-channel parameter.

According to an eighth aspect there is provided an apparatus comprising: an input configured to receive within a period an encoded audio signal comprising at least one frame downmix audio signal and at least one multi-channel audio signal parameter signal comprising a sub-set of a set of frame audio signal multi-channel parameters; a parameter set compiler configured recover any elements of the set of audio signal multi-channel parameters not present in the sub-set of frame audio signal multi-channel parameters; and a multichannel generator configured to generate for the frame at least two channel audio signals from the at least one frame downmix audio signal and the combination of a sub-set of a set of frame audio signal multi-channel parameters and recovered elements of the set of audio signal multi-channel parameters not present in the sub-set of frame audio signal multi-channel parameters.

The set of frame audio signal multi-channel parameters may comprise a set of differences between at least two channels of at least one audio signal, wherein the set of differences may comprise two or more difference values, where each difference value may be associated with a sub-division of resources defining the frame.

The set of differences between at least two channels of the at least one audio signal may comprise at least one of: at least one interaural time difference; and at least one interaural level difference.

The sub-division of resources defining the frame may comprise at least one of: sub-band frequencies; and time periods.

The encoded audio signal may further comprise at least one parameter defining a sub-set of a set of frame audio signal multi-channel parameters; wherein the parameter set compiler configured to recover any elements of the set of audio signal multi-channel parameters not present in the sub-set of frame audio signal multi-channel parameters may be configured to decode the at least one parameter defining a sub-set of a set of frame audio signal multi-channel parameters to determine the sub-set elements to be recovered.

A computer program product may cause an apparatus to perform the method as described herein.

An electronic device may comprise apparatus as described herein.

A chipset may comprise apparatus as described herein.

### BRIEF DESCRIPTION OF DRAWINGS

For better understanding of the present invention, reference will now be made by way of example to the accompanying drawings in which:

FIG. 1 shows schematically an electronic device employing some embodiments;

FIG. 2 shows schematically an audio codec system according to some embodiments;

FIG. 3 shows schematically an encoder as shown in FIG. 2 according to some embodiments;

FIG. 4 shows schematically a channel analyser as shown in FIG. 3 in further detail according to some embodiments;

FIG. 5 shows schematically a stereo parameter encoder as shown in FIG. 3 in further detail according to some embodiments;

FIG. 6 shows a flow diagram illustrating the operation of the encoder shown in FIG. 3 according to some embodiments;

FIG. 7 shows a flow diagram illustrating the operation of the channel analyser as shown in FIG. 4 according to some embodiments;

FIG. 8 shows a flow diagram illustrating the operation of the mono parameter encoder as shown in FIG. 4 according to some embodiments;

FIG. 9 shows a flow diagram illustrating the operation of the stereo parameter encoder as shown in FIG. 5 according to some embodiments;

FIG. 10 shows schematically a band determiner, parameter encoder and parameter selector as shown in FIG. 5 according to some embodiments;

FIG. 11 shows a flow diagram illustrating the operation of the a band determiner, parameter encoder and parameter selector as shown in FIG. 10 according to some embodiments;

FIG. 12 shows schematically a decoder as shown in FIG. 2 according to some embodiments; and

FIG. 13 shows a flow diagram illustrating the operation of the decoder as shown in FIG. 12 according to some embodiments.

### DESCRIPTION OF SOME EMBODIMENTS OF THE APPLICATION

The following describes in more detail possible stereo and multichannel speech and audio codecs, including layered or scalable variable rate speech and audio codecs. However current low bit rate binaural extension layers produce a poor quality decoded binaural signal. This is caused by lack of resolution in the quantization of the binaural parameters (delays and level differences) or by the fact that not all subbands are represented by their corresponding binaural parameter in the encoded bitstream. This is because conventional bitrate constraints for the binaural extension has led to the quantization resolution of the parameters to be decreased (and therefore allowing fewer representation levels) or not all of the subbands are represented by a corresponding parameter. Furthermore typical level differences parameters are coded starting from the higher subbands downwards, for as many subbands as there are bits available thus generating binaural extensions which typically do not generate lower frequency representations.

The concept for the embodiments as described herein is to attempt to generate a stereo or multichannel audio coding that produces efficient high quality and low bit rate stereo (or multichannel) signal coding.

The concept for the embodiments as described herein is thus to generate a coding scheme such that given a number of bits available for the binaural extension for a at least one frame the channel differences (such as level differences) are encoded starting with the subband denoted by “first” sub-band until a “last” subband (for example a sequentially downwards or upwards progression). The “first” sub-band selection is determined from frame to frame in order that a reconstructed frame comprising a combination of the selected sub-bands or other parameters and a weighted version of previous frame selected sub-bands or parameters is closest to the current frame values.

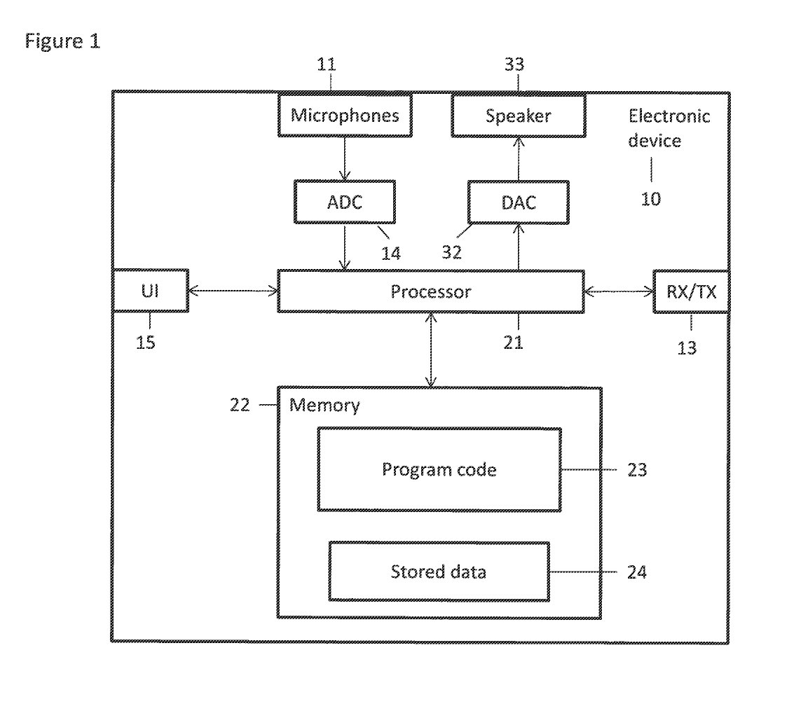

In this regard reference is first made to FIG. 1 which shows a schematic block diagram of an exemplary electronic device or apparatus 10, which may incorporate a codec according to an embodiment of the application.

The apparatus 10 may for example be a mobile terminal or user equipment of a wireless communication system. In other embodiments the apparatus 10 may be an audio-video device such as video camera, a Television (TV) receiver, audio recorder or audio player such as a mp3 recorder/player, a media recorder (also known as a mp4 recorder/player), or any computer suitable for the processing of audio signals.

The electronic device or apparatus 10 in some embodiments comprises a microphone 11, which is linked via an analogue-to-digital converter (ADC) 14 to a processor 21. The processor 21 is further linked via a digital-to-analogue (DAC) converter 32 to loudspeakers 33. The processor 21 is further linked to a transceiver (RX/TX) 13, to a user interface (UI) 15 and to a memory 22.

The processor 21 can in some embodiments be configured to execute various program codes. The implemented program codes in some embodiments comprise a multichannel or stereo encoding or decoding code as described herein. The implemented program codes 23 can in some embodiments be stored for example in the memory 22 for retrieval by the processor 21 whenever needed. The memory 22 could further provide a section 24 for storing data, for example data that has been encoded in accordance with the application.

The encoding and decoding code in embodiments can be implemented in hardware and/or firmware.

The user interface 15 enables a user to input commands to the electronic device 10, for example via a keypad, and/or to obtain information from the electronic device 10, for example via a display. In some embodiments a touch screen may provide both input and output functions for the user interface. The apparatus 10 in some embodiments comprises a transceiver 13 suitable for enabling communication with other apparatus, for example via a wireless communication network.

It is to be understood again that the structure of the apparatus 10 could be supplemented and varied in many ways.

A user of the apparatus 10 for example can use the microphones 11, or array of microphones, for inputting speech or other audio signals that are to be transmitted to some other apparatus or that are to be stored in the data section 24 of the memory 22. A corresponding application in some embodiments can be activated to this end by the user via the user interface 15. This application in these embodiments can be performed by the processor 21, causes the processor 21 to execute the encoding code stored in the memory 22.

The analogue-to-digital converter (ADC) 14 in some embodiments converts the input analogue audio signal into a digital audio signal and provides the digital audio signal to the processor 21. In some embodiments the microphone 11 can comprise an integrated microphone and ADC function and provide digital audio signals directly to the processor for processing.

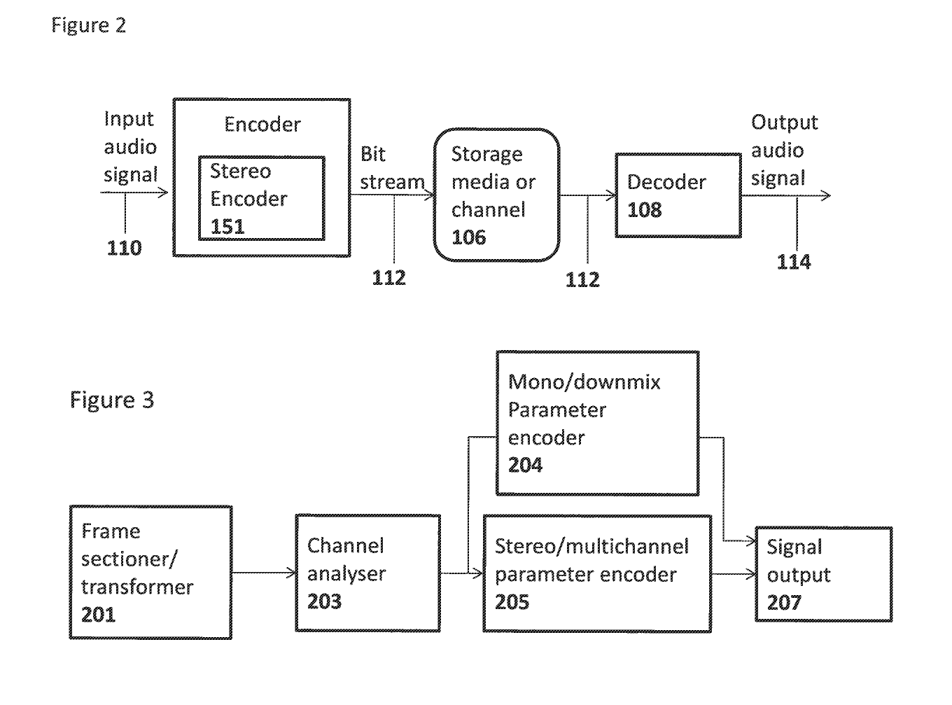

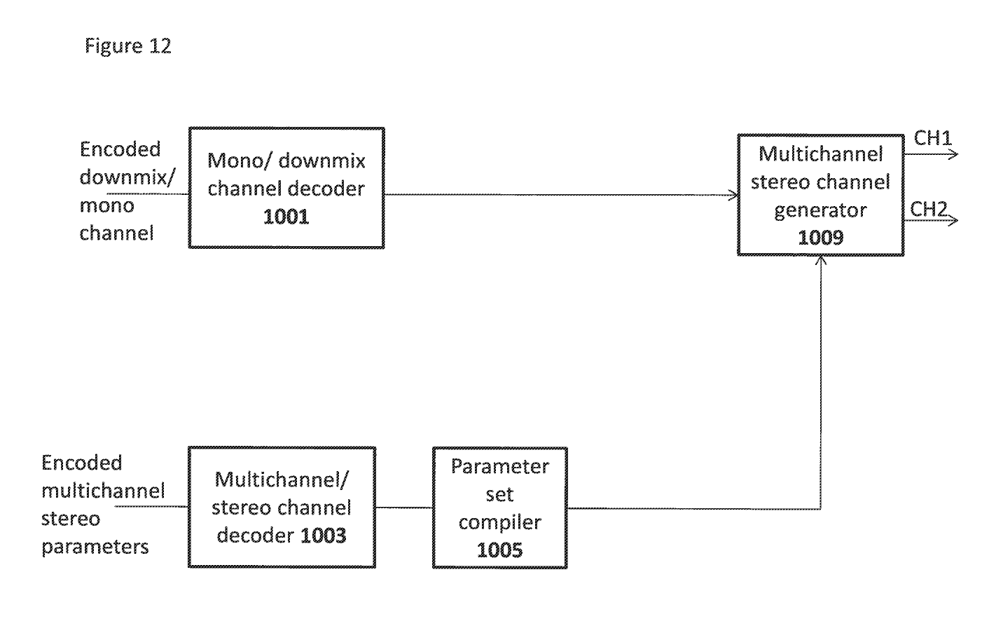

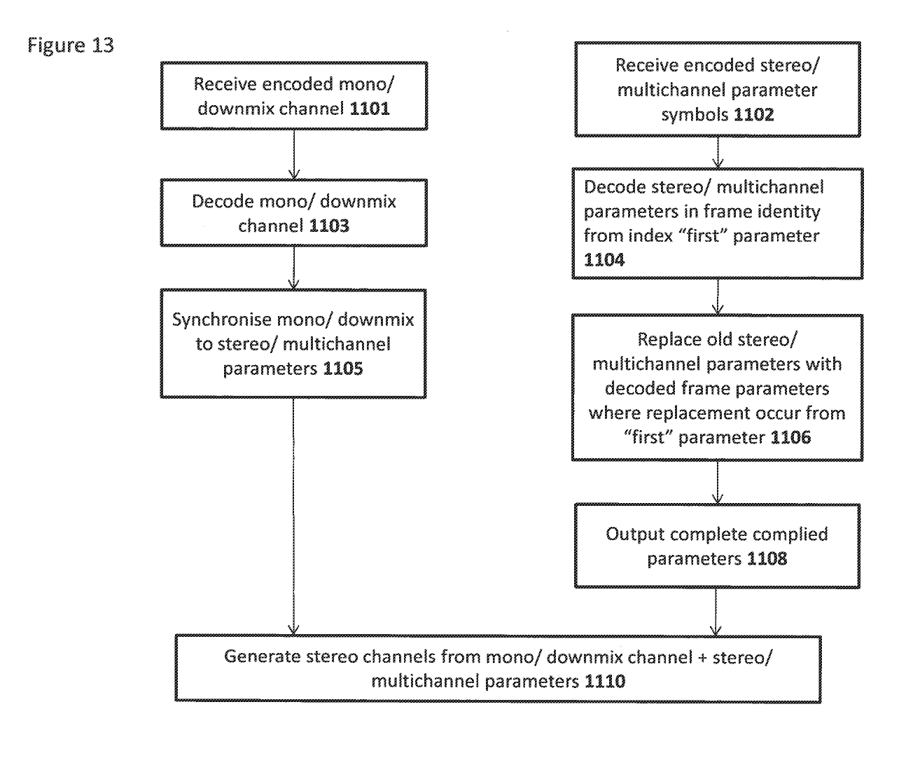

The processor 21 in such embodiments then processes the digital audio signal in the same way as described with reference to the system shown in FIG. 2, the encoder shown in FIGS. 3 to 11 and the decoder as shown in FIGS. 12 and 13.

The resulting bit stream can in some embodiments be provided to the transceiver 13 for transmission to another apparatus. Alternatively, the coded audio data in some embodiments can be stored in the data section 24 of the memory 22, for instance for a later transmission or for a later presentation by the same apparatus 10.

The apparatus 10 in some embodiments can also receive a bit stream with correspondingly encoded data from another apparatus via the transceiver 13. In this example, the processor 21 may execute the decoding program code stored in the memory 22. The processor 21 in such embodiments decodes the received data, and provides the decoded data to a digital-to-analogue converter 32. The digital-to-analogue converter 32 converts the digital decoded data into analogue audio data and can in some embodiments output the analogue audio via the loudspeakers 33. Execution of the decoding program code in some embodiments can be triggered as well by an application called by the user via the user interface 15.

The received encoded data in some embodiment can also be stored instead of an immediate presentation via the loudspeakers 33 in the data section 24 of the memory 22, for instance for later decoding and presentation or decoding and forwarding to still another apparatus.

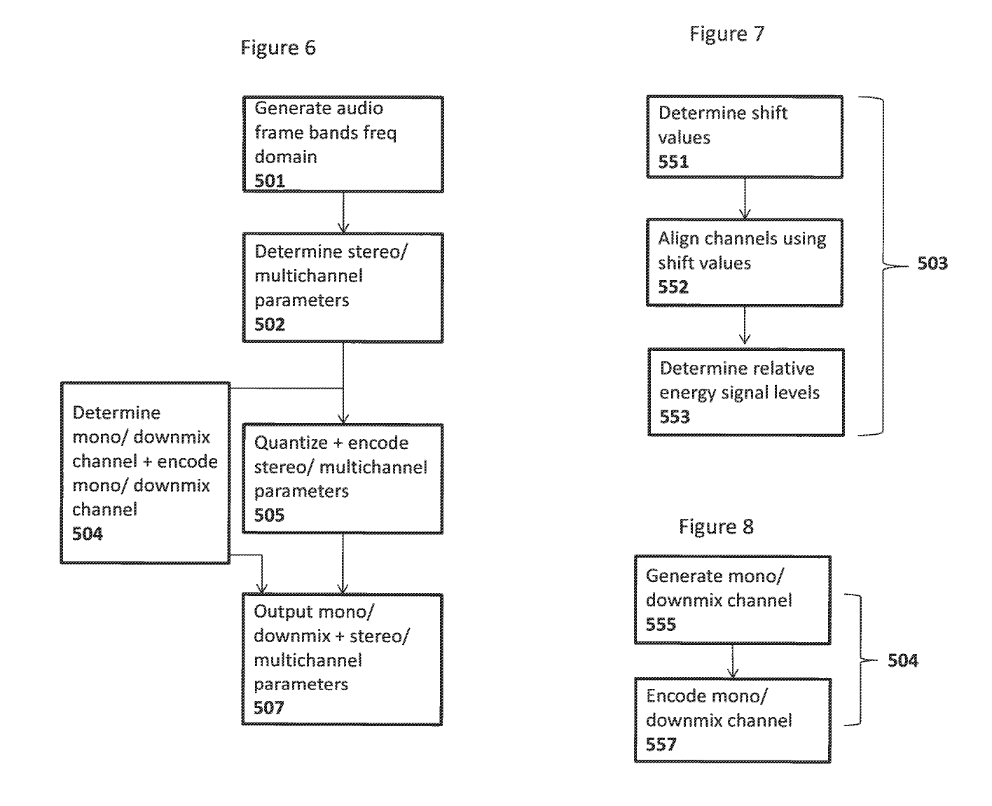

It would be appreciated that the schematic structures described in FIGS. 3 to 5, 10, and 12 and the method steps shown in FIGS. 6 to 9, 11 and 13 represent only a part of the operation of an audio codec and specifically part of a stereo encoder/decoder apparatus or method as exemplarily shown implemented in the apparatus shown in FIG. 1.

The general operation of audio codecs as employed by embodiments is shown in FIG. 2. General audio coding/decoding systems comprise both an encoder and a decoder, as illustrated schematically in FIG. 2. However, it would be understood that some embodiments can implement one of either the encoder or decoder, or both the encoder and decoder. Illustrated by FIG. 2 is a system 102 with an encoder 104 and in particular a stereo encoder 151, a storage or media channel 106 and a decoder 108. It would be understood that as described above some embodiments can comprise or implement one of the encoder 104 or decoder 108 or both the encoder 104 and decoder 108.

The encoder 104 compresses an input audio signal 110 producing a bit stream 112, which in some embodiments can be stored or transmitted through a media channel 106. The encoder 104 furthermore can comprise a stereo encoder 151 as part of the overall encoding operation. It is to be understood that the stereo encoder may be part of the overall encoder 104 or a separate encoding module. The encoder 104 can also comprise a multi-channel encoder that encodes more than two audio signals.

The bit stream 112 can be received within the decoder 108. The decoder 108 decompresses the bit stream 112 and produces an output audio signal 114. The decoder 108 can comprise a stereo decoder as part of the overall decoding operation. It is to be understood that the stereo decoder may be part of the overall decoder 108 or a separate decoding module. The decoder 108 can also comprise a multi-channel decoder that decodes more than two audio signals. The bit rate of the bit stream 112 and the quality of the output audio signal 114 in relation to the input signal 110 are the main features which define the performance of the coding system 102.

FIG. 3 shows schematically the encoder 104 according to some embodiments. FIG. 6 shows schematically in a flow diagram the operation of the encoder 104 according to some embodiments. In the examples provided herein the input audio signal is a two channel or stereo audio signal, which is analysed and a mono parameter representation is generated from a mono parameter encoder and stereo encoded parameters are generated from a stereo parameter encoder. However it would be understood that in some embodiments the input can be any number of channels which are analysed and a downmix parameter encoder generates a downmixed parameter representation and a channel extension parameter encoder generate extension channel parameters.

The concept for the embodiments as described herein is thus to determine and apply a multichannel (stereo) coding mode to produce efficient high quality and low bit rate real life multichannel (stereo) signal coding. To that respect with respect to FIG. 3 an example encoder 104 is shown according to some embodiments. Furthermore with respect to FIG. 6 the operation of the encoder 104 is shown in further detail.

The encoder 104 in some embodiments comprises a frame sectioner/transformer 201. The frame sectioner/transformer 201 is configured to receive the left and right (or more generally any multi-channel audio representation) input audio signals and generate frequency domain representations of these audio signals to be analysed and encoded. These frequency domain representations can be passed to the channel analyser 203.

In some embodiments the frame sectioner/transformer can be configured to section or segment the audio signal data into sections or frames suitable for frequency domain transformation. The frame sectioner/transformer 201 in some embodiments can further be configured to window these frames or sections of audio signal data according to any suitable windowing function. For example the frame sectioner/transformer 201 can be configured to generate frames of 20 ms which overlap preceding and succeeding frames by 10 ms each,

In some embodiments the frame sectioner/transformer can be configured to perform any suitable time to frequency domain transformation on the audio signal data. For example the time to frequency domain transformation can be a discrete Fourier transform (DFT), Fast Fourier transform (FFT), modified discrete cosine transform (MDCT). In the following examples a Fast Fourier Transform (FFT) is used. Furthermore the output of the time to frequency domain transformer can be further processed to generate separate frequency band domain representations (sub-band representations) of each input channel audio signal data. These bands can be arranged in any suitable manner. For example these bands can be linearly spaced, or be perceptual or psychoacoustically allocated.

The operation of generating audio frame band frequency domain representations is shown in FIG. 6 by step 501.

In some embodiments the frequency domain representations are passed to a channel analyser 203.

In some embodiments the encoder 104 can comprise a channel analyser 203 or means for analysing at least one audio signal. The channel analyser 203 can be configured to receive the sub-band filtered representations of the multi-channel or stereo input. The channel analyser 203 can furthermore in some embodiments be configured to analyse the frequency domain audio signals and determine parameters associated with each sub-band with respect to the stereo or multi-channel audio signal differences.

The generated mono (or downmix) signal or mono (or downmix) parameters can in some embodiments be passed to the mono parameter encoder 204.

The stereo parameters (or more generally the multi-channel parameters) can be output to the stereo parameter encoder 205.

In the examples described herein the mono (or downmix) and stereo (or channel extension or multi-channel) parameters are defined with respect to frequency domain parameters, however time domain or other domain parameters can in some embodiments be generated.

The operation of determining the stereo (or channel extension or multi-channel) parameters is shown in FIG. 6 by step 503.

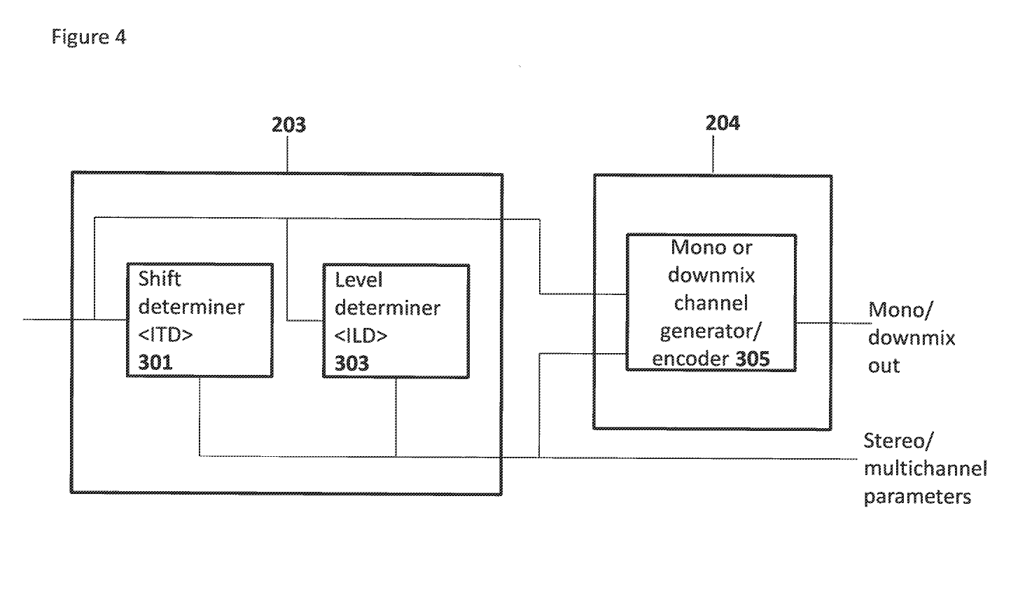

With respect to FIG. 4 an example channel analyser 203 according to some embodiments is described in further detail. Furthermore with respect to FIG. 7 the operation of the channel analyser 203 as shown in FIG. 4 is shown according to some embodiments.

In some embodiments the channel analyser/mono encoder 203 comprises a shift determiner 301 or means for determining a shift between at least two audio signals. The shift determiner 301 is configured to select the shift for a sub-band such that it maximizes the real part of the correlation between the signal and the shifted signal, in the frequency domain. The shifts (or the best correlation indices COR_IND[j]) can be determined for example using the following code.

```
for ( j = 0; NUM_OF_BANDS_FOR_COR_SEARCH; j++ )
  {
    cor = COR_INIT;
    for ( n = 0; n < 2*MAXSHIFT + 1; n++ )
    {
      mag[n] = 0.0f;
      for ( k = COR_BAND_START[j];
      k < COR_BAND_START[j+1]; k++ )
      {
        mag[n] +=
        svec_re[k] * cos( −2*PI*((n−MAXSHIFT) * k / L_FFT );
        mag[n] −=
        svec_im[k] * sin( −2*PI*((n−MAXSHIFT) * k / L_FFT );
      }
      if (mag[n] > cor)
      {
        cor_ind[j] = n − MAXSHIFT;
        cor = mag[n];
      }
    }
  }
```

Where the value MAXSHIFT is the largest allowed shift (the value can be based on a model of the supported microphone arrangements or more simply the distance between the microphones) PI is π, COR_INIT is the initial correlation value or a large negative value to initialise the correlation calculation, and COR_BAND_START [ ] defines the starting points of the sub-bands. The vectors svec_re [ ] and svec_im [ ], the real and imaginary values for the vector, used herein are defined as follows:

```
svec_re[0] = fft_l[0] * fft_r[0];
svec_im[0] = 0.0f;
for (k = 1; k <
COR_BAND_START[NUM_OF_BANDS_FOR_COR_SEARCH];
k++)
{
  svec_re[k] =
  (fft_l[k] * fft_r[k])−(fft_l[L_FFT−k] * (−fft_r[L_FFT−k]));
  svec_im[k] =
  (fft_l[L_FFT−k] * fft_r[k]) + (fft_l[k] * (−fft_r[L_FFT−k]));
}
```

The operation of determining the correlation values is shown in FIG. 7 by step 553.

The correlation values can in some embodiments be passed to the mono channel encoder 204 and as stereo channel parameters to the stereo parameter encoder 205 and in some embodiments the shift difference selector 705.

Furthermore in some embodiments the shift value is applied to one of the audio channels to provide a temporal alignment between the channels. These aligned channel audio signals can in some embodiments be passed to a relative energy signal level determiner 303.

The operation of aligning the channels using the determined shift value is shown in FIG. 7 by step 552.

In some embodiments the channel analyser/encoder 203 comprises a relative energy signal level determiner 303 or means for determining a relative level difference between at least two audio signals. The relative energy signal level determiner 303 is configured to receive the output aligned frequency domain representations and determine the relative signal levels between pairs of channels for each sub-band. It would be understood that in the following examples a single pair of channels are analysed by a suitable stereo channel analyser and processed however it would be understood that in some embodiments this operation can be extended to any number of channels (in other words a multi-channel analyser or suitable means for analysing multiple or two or more channels to determine parameters defining the channels or differences between the channels. This can be achieved for example by a suitable pairing of the multichannels to produce pairs of channels which can be analysed as described herein.

In some embodiments the relative level for each band can be computed using the following code.

```
For (j = 0; j < NUM_OF_BANDS_FOR_SIGNAL_LEVELS; j++)
  {
    mag_l = 0.0;
    mag_r = 0.0;
    for (k = BAND_START[j]; k < BAND_START[j+1]; k++)
    {
      mag_l +=
      fft_l[k]*fft_l[k] + fft_l[L_FFT−k]*fft_l[L_FFT−k];
      mag_r +=
      fft_r[k]*fft_r[k] + fft_r[L_FFT−k]*fft_r[L_FFT−k];
    }
    mag[j] =
    10.0f*log10(sqrt((mag_l+EPSILON)/(mag_r+EPSILON)));
  }
```

Where L_FFT is the length of the FFT and EPSILON is a small value above zero to prevent division by zero problems. The relative energy signal level determiner in such embodiments effectively generates magnitude determinations for each channel (for example in a stereo channel configuration the left channel L and the right channel R) over each sub-band and then divides one channel value by the other to generate a relative value. In some embodiments the relative energy signal level determiner 303 is configured to output the relative energy signal level to the mono (or downmix) parameter encoder 204 and the stereo (or multichannel or channel extension) parameter encoder 205 and in some embodiments the level difference selector 703.

The operation of determining the relative energy signal level is shown in FIG. 7 by step 553.

In some embodiments any suitable inter level (energy) and inter temporal (shift or delay) difference estimation can be performed. For example for each frame there can be two windows for which the shift (delay) and levels are estimated. Thus for example where each frame is 10 ms there may be two windows which may overlap and are delayed from each other by 5 ms. In other words for each frame there can be determined two separate delay and level difference values which can be passed to the encoder for encoding.

Furthermore in some embodiments for each window the differences can estimated for each of the relevant sub-bands. The division of sub-bands can in some embodiments be determined according to any suitable method.

For example the sub-band division in some embodiments which then determines the number of inter level (energy) and inter temporal (shift or delay) difference estimation can be performed according to a selected bandwidth determination. For example the generation of audio signals can be based on whether the output signal is considered to be wideband (WB), superwideband (SWB), or fullband (FB) (where the bandwidth requirement increases in order from wideband to fullband). For the possible bandwidth selections there can in some embodiments be a particular division in subbands. Thus for example the sub-band division for the FFT domain for temporal or delay difference estimates can be:

ITD sub-bands for Wideband (WB)
const short scale1024_WB [ ]=(1, 5, 8, 12, 20, 34, 48, 56, 120, 512);

ITD sub-bands for Superwideband (SWB)
const short scale1024_SWB [ ]=(1, 2, 4, 6, 10, 14, 17, 24, 28, 60, 256, 512);

ITD sub-bands for Fullband (FB)
const short scale1024_FB[ ]=(1, 2, 3, 4, 7, 11, 16, 19, 40, 171, 341, 448/*˜21 kHz*/);

ILD sub-bands for Wideband (WB)
const short scf_band_WB[ ]=(1, 8, 20, 32, 44, 60, 90, 110, 170, 216, 290, 394, 512);

ILD sub-bands for Superwideband (SWB)
const short scf_band_SWB[ ]=(1, 4, 10, 16, 22, 30, 45, 65, 85, 108, 145, 197, 256, 322, 412, 512);

ILD sub-bands for Fullband (FB)
const short scf_band_FB[ ]=(1, 3, 7, 11, 15, 20, 30, 43, 57, 72, 97, 131, 171, 215, 275, 341, 391, 448/*˜21 kHz*/);

In other words in some embodiments there can be different sub-bands for delays and levels differences.

As shown in FIG. 4 the encoder can further comprise a mono parameter encoder 204 (or more generally the downmix parameter encoder or means for encoding at least one downmix parameter). The operation of the example mono (downmix) parameter encoder 204 is shown in FIG. 8.

In some embodiments the apparatus comprises a mono (or downmix) parameter encoder 204. The mono (or downmix) parameter encoder 204 in some embodiments comprises a mono (or downmix) channel generator/encoder 305 configured to receive the channel analyser values such as the relative energy signal level from the relative energy signal level determiner 303 and the shift level from the shift determiner 301. Furthermore in some embodiments the mono (downmix) channel generator/encoder 305 can be configured to further receive the input stereo (multichannel) audio signals. The mono (downmix) channel generator/encoder 305 can in some embodiments be configured to apply the shift (delay) and level differences to the stereo (multichannel) audio signals to generate an ‘aligned’ mono (or downmix) channel which is representative of the audio signals. In other words the mono (downmix) channel generator/encoder 305 can generate a mono (downmix) channel signal which represents an aligned stereo (multichannel) audio signal. For example in some embodiments where there is determined to be a left channel audio signal and a right channel audio signal one of the left or right channel audio signals are delayed with respect to the other according to the determined delay difference and then the delayed channel and other channel audio signals are averaged to generate a mono channel signal. However it would be understood that in some embodiments any suitable mono channel generating method can be implemented. It would be understood that in some embodiments the mono channel generator or suitable means for generating audio channels can be replaced by or assisted by a ‘reduced’ (or downmix) channel number generator configured to generate a smaller number of output audio channels than input audio channels. Thus for example in some multichannel audio signal examples where the number of input audio signal channels is greater than two the ‘mono channel generator’ is configured to generate more than one channel audio signal but fewer than the number of input channels.

The operation of generating a mono channel signal (or reduced number of channels) from a multichannel signal is shown in FIG. 8 by step 555.

The mono (downmix) channel generator/encoder 305 can then in some embodiments encode the generated mono (downmix) channel audio signal (or reduced number of channels) using any suitable encoding format. For example in some embodiments the mono (downmix) channel audio signal can be encoded using an Enhanced Voice Service (EVS) mono (or multiple mono) channel encoded form, which may contain a bit stream interoperable version of the Adaptive Multi-Rate—Wide Band (AMR-WB) codec.

The operation of encoding the mono channel (or reduced number of channels) is shown in FIG. 8 by step 557.

The encoded mono (downmix) channel signal can then be output. In some embodiments the encoded mono (downmix) channel signal is output to a multiplexer to be combined with the output of the stereo parameter encoder 205 to form a single stream or output. In some embodiments the encoded mono (downmix) channel signal is output separately from the stereo parameter encoder 205.

The operation of determining a mono (downmix) channel signal and encoding the mono (downmix) channel signal is shown in FIG. 6 by step 504.

In some embodiments the encoder 104 comprises a stereo (or extension or multi-channel) parameter encoder 205 or means for encoding an extension parameter. In the following example the multi-channel parameter encoder is a stereo parameter encoder 205 or suitable means for encoding the multi-channel parameters. The stereo parameter encoder 205 can be configured to receive the multi-channel parameters such as the stereo (difference) parameters determined by the channel analyser 203. The stereo parameter encoder 205 can then in some embodiments be configured to perform a quantization on the parameters and furthermore encode the parameters so that they can be output (either to be stored on the apparatus or passed to a further apparatus).

The operation of quantizing and encoding the quantized stereo parameters is shown in FIG. 6 by step 505.

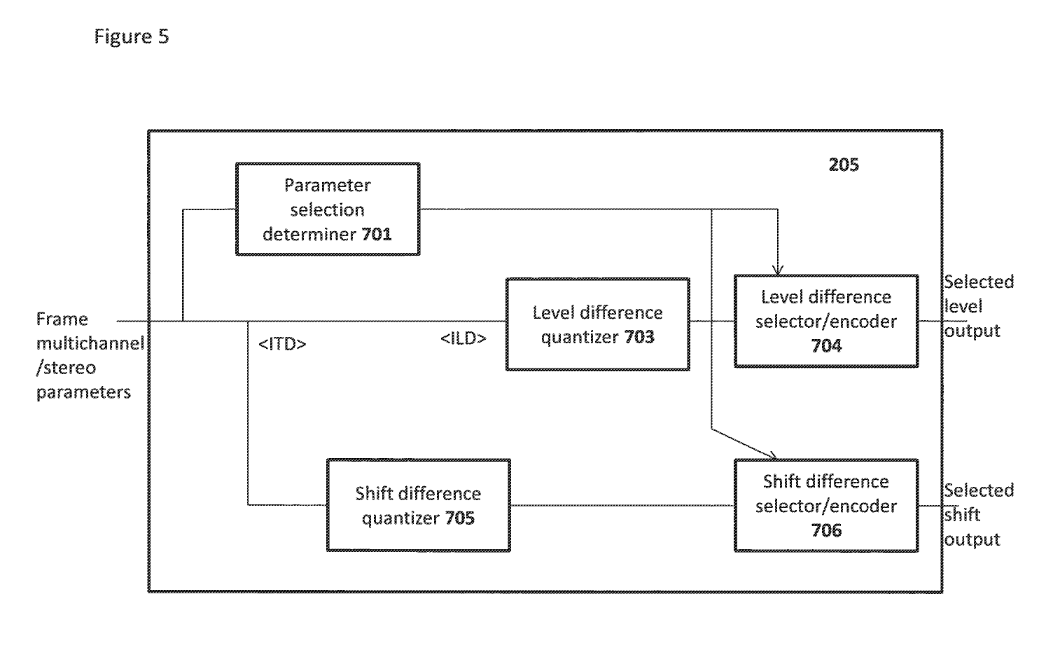

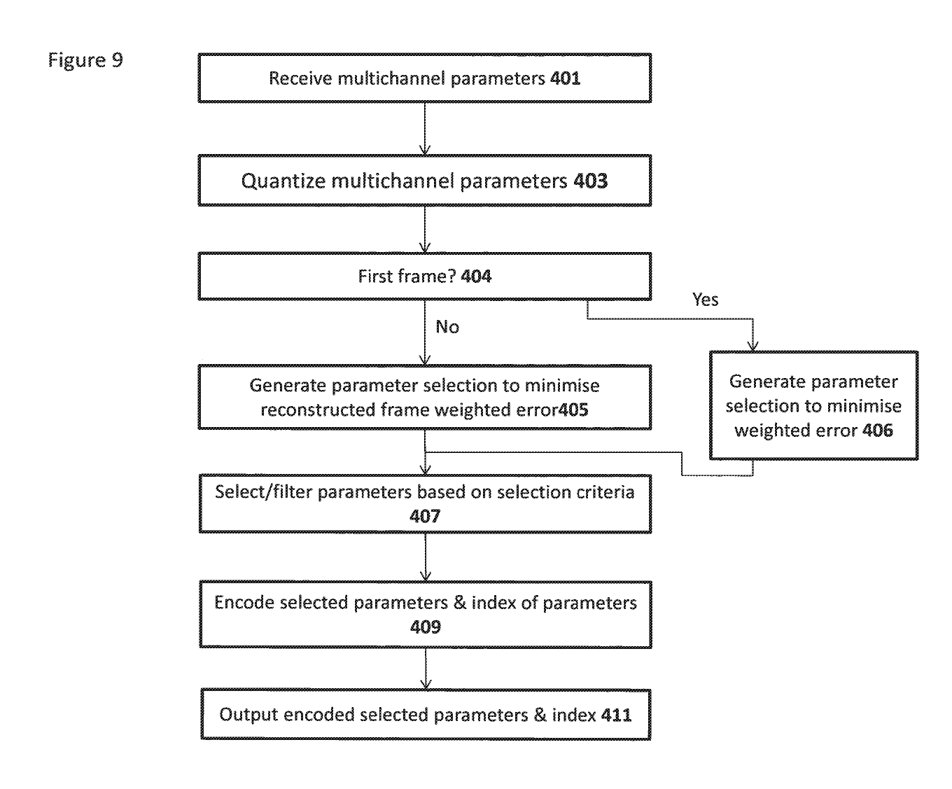

With respect to FIG. 5 an example stereo/multi-channel parameter encoder 205 is shown in further detail. Furthermore with respect to FIG. 9 the operation of the stereo/multi-channel parameter encoder 205 according to some embodiments is shown,

In some embodiments the stereo/multi-channel parameter encoder 205 is configured to receive the stereo/multi-channel parameters in the form of the channel level differences (ILD) and the channel delay differences (ITD).

The stereo/multi-channel parameters can in some embodiments be passed to a level difference quantizer 703, for the ILD values, and a shift difference quantizer 705 for the ITD values.

The operation of receiving the stereo/multi-channel parameters is shown in FIG. 9 by step 401.

In some embodiments the stereo/multi-channel parameter encoder 205 comprises a level difference quantizer 703 (or means for quantizing level difference parameters). The level difference quantizer 703 is configured to receive the inter-level differences (ILD) frame stereo/multi-channel parameters. The level difference quantizer 703 is then configured to quantize the ILD parameters for the sub-bands. The quantized level difference values can be passed to a level difference selector and encoder 704 and also to the parameter selection determiner 701.

Furthermore in some embodiments the stereo/multi-channel parameter encoder 205 comprises a shift difference quantizer 705 (or means for quantizing shift difference parameters). The shift difference quantizer 705 is configured to receive the inter-temporal difference (ITD) values of the frame stereo/multi-channel parameters. The shift difference quantizer 705 can then be configured to quantize the sub-band difference parameter values and pass these values to a shift difference selector and encoder 706 and also to the parameter selection determiner 701.

The operation of quantizing the parameter values is shown in FIG. 9 by step 403.

In some embodiments the stereo/multi-channel parameter encoder 205 comprises a parameter selection determiner 701 or means for determining a parameter selection criteria. The parameter selection determiner 701 is configured to determine a parameter selection criteria which can be passed to the difference selector and encoder to enable selective encoding of the difference parameters.

In some embodiments the parameter selection determiner 701 is configured to determine whether the current frame being processed is an initial, reference or first frame.

The operation of determining whether the currently processed frame is the first frame is shown in FIG. 9 by step 403.

In some embodiments the parameter selection determiner 701, on determining that the current frame is an initial, reference or first frame (in other words there is no memory of any previously encoded parameters) then the parameter selection determiner can further be configured to generate a parameter selection criteria (or means for determining a selection criteria) to minimise a weighted error value based on the candidate selection parameters and the current multichannel parameters (or their quantized forms) for a specific number of selected parameters. Thus in some embodiments the parameter selection determiner 701 is configured to determine the available bitrate or other suitable capacity and therefore determine the maximum number of selected parameters that can be encoded for that number of bits for the current frame and select from a ‘first’ parameter to a ‘last’ parameter the maximum number of selected parameters, where the ‘first’ and therefore the ‘last’ parameter selection criteria determined by the error value.

In the following examples the error is determined based on the difference between the received or unquantized parameters and the selected quantized parameters. However it would be understood that in some embodiments the same error analysis can be made between quantized parameters and selected received ‘unquantized’ parameters or any combination of received (quantized or not) and selected (quantized or not) parameters. The parameter selection criterion is configured to determine which of the determined sub-band stereo/multi-channel parameters are to be selected and encoded by the difference selector and encoder such as the level difference selector and encoder 704 and the shift difference selector and encoder 706.

The operation of determining the initial frame selection criteria based on minimising the error between selected and received parameters for a number of selected parameters is shown in FIG. 9 by step 406.

In some embodiments the initial sub-band stereo/multi-channel parameters are selected according to any suitable criteria. For example in some embodiments the parameter selection determiner 701 is configured to determine the initial frame selection criteria as a sequential selection algorithm in decreasing frequency order. In other words where there are 10 multichannel parameters per frame generated by the channel analyser where the sub-bands are represented from highest frequency to lowest frequency by the indices 1 to 10 then for the first frame particular frame (i) a first number of sub-bands are selected (for example the first 5 sub-band stereo/multi-channel parameters 1,2,3,4,5)

In some embodiments the parameter selection determiner 701, on determining that the current frame is not an initial, reference or first frame (in other words there is a stored version or memory of previously encoded parameters) then the parameter selection determiner can further be configured to generate a parameter selection criteria (or means for determining a selection criteria) to minimise a weighted error value based on the candidate selection parameters and any previous frame selections and the current multichannel parameters (or their quantized forms) for a specific number of selected parameters. Thus in some embodiments the parameter selection determiner 701 is configured to determine the available bitrate or other suitable capacity and therefore determine the maximum number of selected parameters that can be encoded for that number of bits for the current frame and select from a ‘first’ parameter to a ‘last’ parameter the maximum number of selected parameters, where the ‘first’ and therefore the ‘last’ parameter selection criteria determined by the error value.

As described herein in the following examples the error is determined based on the difference between the received or unquantized parameters and the reconstructed quantized parameters. However it would be understood that in some embodiments the same error analysis can be made between quantized parameters and reconstructed received ‘unquantized’ parameters or any combination of received (quantized or not) and reconstructed (quantized or not) parameters. The parameter selection criterion is configured to determine which of the determined sub-band stereo/multi-channel parameters are to be selected and encoded by the difference selector and encoder such as the level difference selector and encoder 704 and the shift difference selector and encoder 706.

The operation of determining the further frame selection criteria based on minimising the error between selected and reconstructed parameters for a number of selected parameters is shown in FIG. 9 by step 405.

Furthermore in some embodiments it would be understood that the number of selected sub-bands or parameters can differ from frame to frame. For example the parameter selection determiner 701 can be configured to select a number of sub-bands based on the available bandwidth for transmitting the parameters on a frame by frame basis.

In some embodiments the parameter selection determiner 701 can be configured to output similar or the same determined sub-band selections to the shift difference selector and encoder 704 and to the level difference selector and encoder 706. However it would be appreciated that in some embodiments the parameter selection determiner 701 applies different selection criteria to the level difference values than the shift difference values. In some embodiments the parameter selection determiner 701 can be configured to determine or apply a limited selection criteria to the level difference parameter values and select all of the sub-bands for the shift difference parameter values or vice versa. Furthermore in some embodiments the difference between determined selections of level difference parameter values and shift difference parameter values can be dependent on the available bandwidth for the parameter encodings and for the level difference parameter values and the shift difference parameter values.

The parameter selection determiner 701 can then output the selection criteria (in other words the sub bands to be selected) to the shift difference selector and encoder 706 and the level difference selector and encoder 704.

In some embodiments the multi-channel parameter encoder 205 comprises a level difference selector and encoder 704 (or means for selecting level difference parameters and means for encoding the selected level difference parameters). The level difference selector and encoder 704 is configured to receive the inter-level differences (ILD) frame stereo/multi-channel parameters and furthermore to receive the sub-band selections from the parameter selection determiner 701. The level difference selector and encoder 704 is then configured to select or filter the ILD parameters for the indicated sub-bands. The selected level difference values can be encoded.

Furthermore in some embodiments the multi-channel parameter encoder 205 comprises a shift difference selector and encoder 706 (or means for selecting shift difference parameters and means for encoded the selected shift difference parameters). The shift difference selector and encoder 706 is configured to receive the inter-temporal difference (ITD) values of the frame stereo/multi-channel parameters and the selection criteria values from the parameter selection determiner 701. The shift difference selector and encoder 706 can then be configured to select the indicated sub-band difference parameter values and then encode them.

The operation of selecting or filtering the difference parameters based on the selection criteria is shown in FIG. 9 by step 407.

In some embodiments the multi-channel parameter encoder 205 level difference selector and encoder 704 (or means for encoding a level difference parameter) is configured to encode or quantize in a suitable manner the selected level difference parameters and output the selected level and ‘first’ values in an encoded form. In some embodiments these can be multiplexed with the mono/downmix encoded signals or be passed separately to a decoder (or memory for storage). The starting position or ‘first’ index in some embodiments can be quantized with sparse resolution and additionally Huffman-coding can be used to code the most often used starting positions with as few bits as possible. Furthermore in some embodiments the encoder can be configured to receive and encode the sequence selection where there is more than one possible sequence of selections available and pass these to the decoder so to enable the decoder to reconstruct the selection sequence. The sequence selection can similarly be entropy encoded of Huffman-coded.

In some embodiments the difference values are vector quantized or encoded using 2 dimensional codebooks. However in some embodiments the level difference encoder can be configured to use index remapping based on a determined frequency of occurrence and Golomb-Rice encoding (or and other suitable entropy coding) the index value to reduce on average the number of bits required to encode each value.

Similarly the multi-channel parameter encoder 205 shift difference selector and encoder 406 (or means for encoding a shift difference parameter) is configured to encode the selected shift difference parameters in a suitable manner such as vector quantisation or other forms. Furthermore in some embodiments the shift difference selector and encoder 706 is configured to encode the ‘first’ value. In other words the starting position for the current frame estimated for each frame can be encoded. The starting position or ‘first’ index in some embodiments can be quantized with sparse resolution and additionally Huffman-coding can be used to code the most often used starting positions with as few bits as possible. Furthermore in some embodiments the encoder can be configured to receive and encode the sequence selection where there is more than one possible sequence of selections available and pass these to the decoder so to enable the decoder to reconstruct the selection sequence.

The operation of encoding the selected parameters and the ‘first’ or index value for the frame indicating the first encoded value is shown in FIG. 9 by step 409.

Furthermore the outputting of encoded selected parameters is shown in FIG. 9 by step 411.

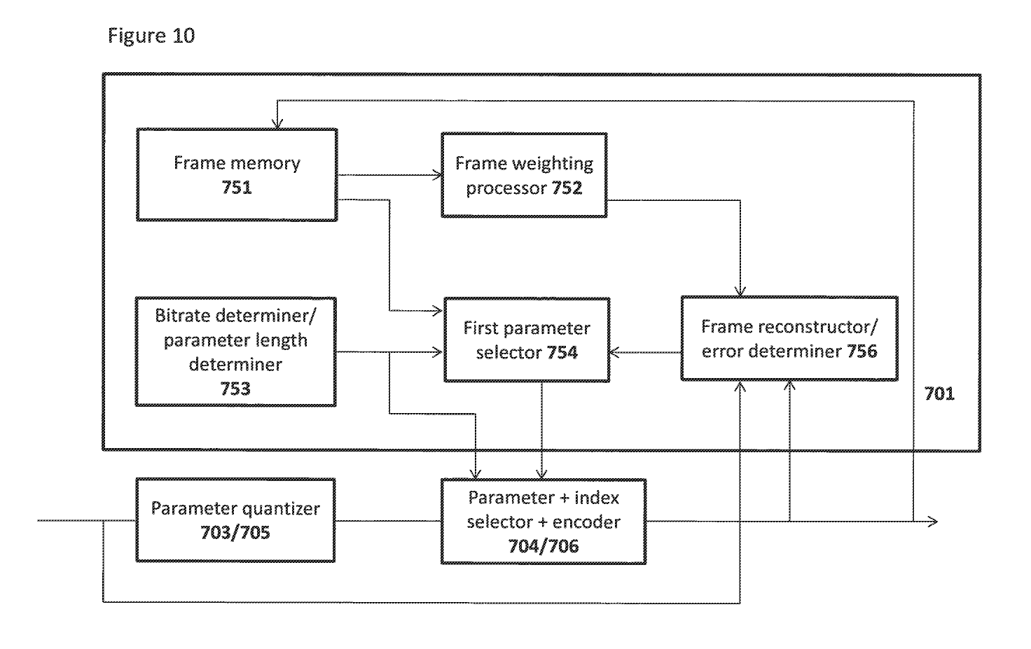

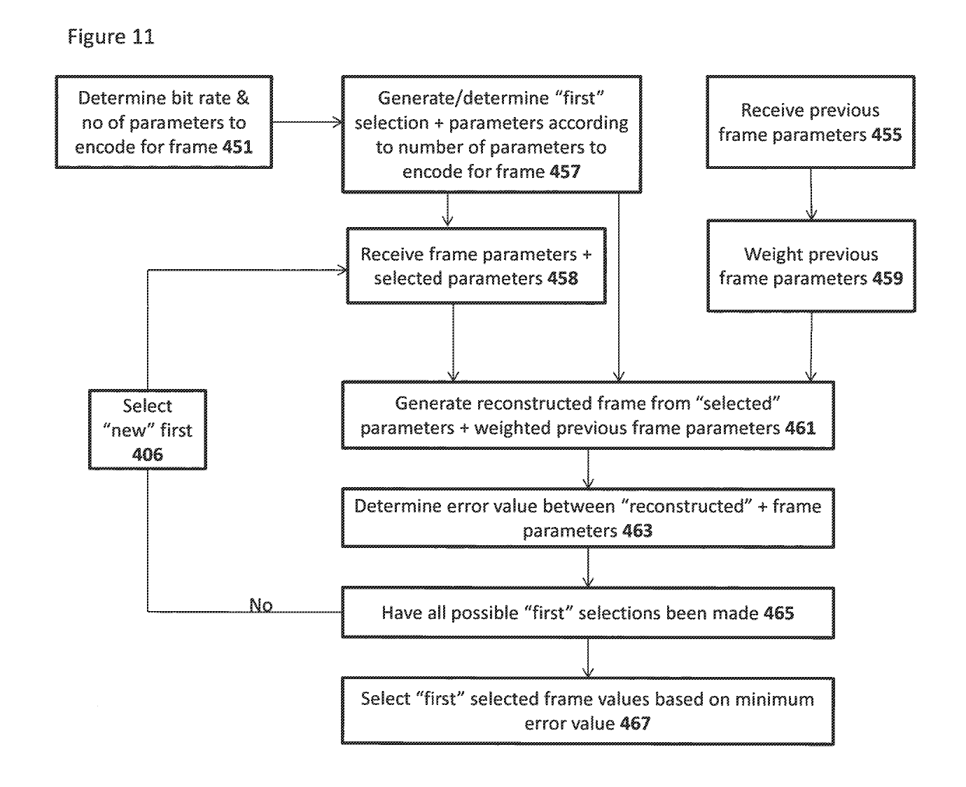

With respect to FIG. 10 an example of the parameter selection determiner 701 is shown in further detail according to some embodiments. Furthermore with respect to FIG. 11 the operation of the parameter selection determiner 701 according to the example shown in FIG. 10 is described in further detail by a flow diagram.

In some embodiments the parameter selection determiner 701 comprises a bit rate determiner (parameter length determiner) 753. The bit rate determiner (parameter length determiner) 753 is configured to determine the available bit rate for the frame or in other words the number of bits available for encoding multichannel parameters for the current frame. The parameter selection determiner can then from the available bit rate or number of bits for the frame determine the number of parameters that can be encoded for the frame. In some embodiments the number of bits required for each encoded parameter is estimated based on a known function.

The bit rate determiner/parameter length determiner 753 can output the number of parameters which can be encoded (in other words the selection ‘length’ value) to the first parameter selector 754.

The operation of determining a bit rate and a number of parameters to encode for the frame is shown in FIG. 11 by step 451.

In some embodiments the parameter selection determiner 701 comprises a frame memory 751. The frame memory 751 is configured to store a reproduction of the previous frames parameters in terms of the most recently determined or selected parameters. The frame memory 751 can therefore be considered to be a version of the available parameters which would have been available at a decoder at the same time as the current frame is to be processed.

The frame memory 751 can be configured to output the content of the frame memory to a frame weighting processor 752.

The operation of receiving or retrieving previous frames parameters is shown in FIG. 11 by step 455.

Furthermore in some embodiments the parameter selection determiner 701 comprises a frame weighting processor 752. The frame weighting processor receives from the frame memory 751 the previous frame parameters and applies a weighting factor to these parameters. For example in some embodiments the frame weighting factor is a 0.8 multiplication factor per frame which is applied to each of the frame memory parameters before the weighted frame parameters are passed to the frame reconstructor/error determiner 756. It would be understood that in some embodiments there is no previous frame weighting, in other words the frame weighting factor is 1.

The operation of weighting the previous frame parameters is shown in FIG. 11 by step 459.

In some embodiments the parameter selection determiner 701 comprises a first parameter selector 754. The first parameter selector 754 can be configured to receive the number of parameters to be encoded for the current frame from the parameter length determiner 753.

In some embodiments the first parameter selector 754 can be configured to generate or determine a first selection value, in other words the first parameter to be selected and encoded and furthermore select the other parameters for the current frame upto the ‘last’ parameter in the sequence. In some embodiments the sequence of selection is a modulo incremental index selection where the sub-bands are selected in decreasing frequency sub-bands from the ‘first’ selected sub-band for the frame to the ‘last’ selected sub-band for the frame, where during the sequence the lowest frequency sub-band is reached the sequence returns to the highest frequency sub-band and continues in decreasing frequency.

The following examples show the selection sequence to be a decreasing frequency sub-band or increasing index parameter where the sub-bands are indexed from the highest to the lowest frequencies. For example where there are 10 sub-bands parameters designated b₁ as the highest frequency sub-band parameter to b₁₀ as the lowest frequency sub-band parameter then a possible 3 parameter selection starting from b₁ is b₁,b₂,b₃. It would be understood that the selection sequence can be in some embodiments any suitable sequence or sequences. For example in some embodiments the selection sequence can be incrementing frequency sub-bands (or decreasing index parameter selection for example a possible 3 parameter selection starting from b₁ is b₁,b₁₀,b₉. Other sequence selections can in some embodiments have gaps between selections. For example alternating indexed parameters in decreasing frequencies (for 3 odd indexed parameters starting from b₁=b₁,b₃,b₅ or 3 even indexed parameters starting from b₂=b₂,b₄,b₆) or increasing frequencies (for 3 odd indexed parameters starting from b₁=b₁,b₈,b₇ or 3 even indexed parameters starting from b₂=b₂,b₁₀,b₆). The selection sequence in some embodiments can have a consistent selection step (which can be more than 2 as shown herein) or can have a variable selection step.

In some embodiments the selection sequence can attempt to use correlation between lower and upper parts of the frequency range. Thus the sequence in some embodiments can be configured to select a first sub-band and then select the corresponding sub-band in the other half of the sub-band portion (for example a 3 parameter selection can be (b₁[the first parameter selected], b₆ [the corresponding parameter in the lower half of the frequency range], b₂ [the next selection in the upper band]).

In some embodiments where there is more than one selection sequence being used in a single frame then the first parameter selector 754 is configured to indicate this to the parameter and index selector and encoder.

The operation of generating or determining the first selection and the selected parameters for the frame is shown in FIG. 11 by step 457.

The first parameter selector 754 can in some embodiments output the indication of which parameters to be selected to the parameter and index selector/encoder which can generate a candidate parameter output to be passed to a frame reconstructor/error determiner 756. The parameter and index selector/encoder can for example be the level difference selector/encoder 704 and/or the shift difference selector/encoder.

In some embodiments the parameter selection determiner 701 comprises a frame reconstructor/error determiner 756. The frame reconstructor/error determiner 756 is configured to receive the current frame parameters (or in some embodiments the quantized current frame parameters where the error determination is between quantized parameters) and furthermore the candidate current frame selected parameters.

The operation of receiving the frame parameters and selected parameters is shown in FIG. 11 by step 458.

In some embodiments the frame reconstructor/error determiner 756 is configured to generate a reconstructed frame from the selected quantised parameters and the weighted previous frame parameters. This is effectively the operation of generating a decoder viewpoint where the decoder receives the selected current frame parameters and any previous parameters (where weighted). It would be understood that in some embodiments the reconstructed frame for a first frame is formed only from the selected parameters.

The operation of generating a reconstructed frame from the selected parameters and (weighted) previous frame parameters is shown in FIG. 11 by step 461.

Furthermore the frame reconstructor/error determiner 756 is in some embodiments configured to determine an error value between the reconstructed and frame parameters. In some embodiments the error value can be a distance between the vector of the reconstructed parameters and the vector of the parameters. It would be understood that in some embodiments as discussed herein that the error value is determined from the distance between the vector of the reconstructed parameters and the vector of the quantized parameters.

The operation of generating or determining the error value between the reconstructed and frame parameters is shown in FIG. 11 by step 463.

In some embodiments the frame reconstructor/error determiner 756 can be configured to store this error value against the first index value (and in some embodiments the selection sequence mode).

In some embodiments the frame reconstructor/error determiner can further determine whether or not all of the ‘first’ selections have been made. In some embodiments the search of the ‘first’ parameter selections is an exhaustive search, in other words all possible ‘first’ selections are tested and the error value determined. In some embodiments the search of the ‘first’ parameter selections is one which attempts to determine a local minimum only.

The operation of determining whether all ‘possible’ first parameter selections have been made is shown in FIG. 11 by step 465.

Where there are further first selections possible then the frame reconstructor/error determiner 756 can be configured to indicate this to the first parameter selector 754 which generates a further ‘first’ parameter and sequence selection and passes this selection to the parameter index selector and encoder.

The operation of selecting a new first parameter value is shown in FIG. 11 by step 406 and the operation passes the back to the operation shown in FIG. 11 by step 457.

Where all of the ‘possible’ first parameter selections have been made then the frame reconstructor/error determiner 756 can be configured to indicate to the first parameter selector 754 which of the first parameter values had the minimum error value. The first parameter selector 754 can then output this to the parameter and index selector and encoder.

The operation of generating the frame ‘first’ parameter selection and other selected parameters based on the minimum error value is shown in FIG. 11 by step 467.

In the following section it is given an example of the operation of some embodiments for a binaural extension at the current frame using level differences as the parameters to be encoded.

In this example the level differences are selected and encoded from the first frame using the sequence starting with the sub-band denoted by “first” and downwards in frequency,

Furthermore in this example the level parameters can be quantized in according to the following quantization levels {−10, −6, −4, −2, 0, 2, 4, 6, 10}.

In this example the parameter selection determiner determines that there are enough bits to code downwards only 5 sub-band level parameters and the quantized level values for the total of 10 sub-bands are (from highest frequency sub-bands downwards):

x {b₁ b₂ b₃ b₄ b₅ b₆ b₇ b₈ b₉ b₁₀}={1.6 1.8 3.4 −4.4 2.1 −2.3 −5.6 −9.3 6.3 4.3}

x_hat {b₁ b₂ b₃ b₄ b₅ b₆ b₇ b₈ b₉ b₁₀}={2 2 4 −4 2 −2 −6 −10 6 4}

where x_hat is the quantized version of x.

According to a first embodiment the first parameter selector determines a first frame selection using the first 5 parameters (in other words the first parameter is b₁ and the last one b₅ and using a null or 0 value for the rest). In this example the reconstructed parameter values would be:

recx {b₁ b₂ b₃ b₄ b₅ b₆ b₇ b₈ b₉ b₁₀}={2 2 4 −4 2 0 0 0 0 0},

It would be understood that in some embodiments the first parameter selector determines a first frame selection 5 parameters but searching for the minimum error value determined by

diff=∥recx-x₁₃ hat∥

In such embodiments the possible selections and diff values are

| b1 | b2 | b3 | b4 | b5 | b6 | b7 | b8 | b9 | b10 | Diff |
|---|---|---|---|---|---|---|---|---|---|---|
| 2 | 2 | 4 | −4 | 2 | −2 | −6 | −10 | 6 | 4 | |
| 2 | 2 | 4 | −4 | 2 | 0 | 0 | 0 | 0 | 0 | 28 |
| 0 | 2 | 4 | −4 | 2 | −2 | 0 | 0 | 0 | 0 | 28 |
| 0 | 0 | 4 | −4 | 2 | −2 | −6 | 0 | 0 | 0 | 24 |
| 0 | 0 | 0 | −4 | 2 | −2 | −6 | −10 | 0 | 0 | 18 |
| 0 | 0 | 0 | 0 | 2 | −2 | −6 | −10 | 6 | 0 | 16 |
| 0 | 0 | 0 | 0 | 0 | −2 | −6 | −10 | 6 | 4 | 14 |
| 2 | 0 | 0 | 0 | 0 | 0 | −6 | −10 | 6 | 4 | 14 |
| 2 | 2 | 0 | 0 | 0 | 0 | 0 | −10 | 6 | 4 | 18 |
| 2 | 2 | 4 | 0 | 0 | 0 | 0 | 0 | 6 | 4 | 24 |
| 2 | 2 | 4 | −4 | 0 | 0 | 0 | 0 | 0 | 4 | 26 |

and as such in some embodiments the first frame selected parameters to output are

recx {b₁ b₂ b₃ b₄ b₅ b₆ b₇ b₈ b₉ b₁₀}={0 0 0 0 0 −2 −6 −10 6 4} or

recx {b₁ b₂ b₃ b₄ b₅ b₆ b₇ b₈ b₉ b₁₀}={2 0 0 0 0 0 −6 −10 6 4}

Where diff=∥x-x_rec∥² then the first frame selected parameters to output are

recx {b1 b2 b3 b4 b5 b6 b7 b8 b9 b10}={0 0 0 0 0 −2 −6 −10 6 4}

according to the following table showing the diff values for five selected parameters:

| b1 | b2 | b3 | b4 | b5 | b6 | b7b | b8 | b9 | b10 | Diff |
|---|---|---|---|---|---|---|---|---|---|---|
| 1.6 | 1.8 | 3.4 | −4.4 | 2.1 | −2.3 | −5.6 | −9.3 | 6.3 | 4.3 | |
| 2 | 2 | 4 | −4 | 2 | 0 | 0 | 0 | 0 | 0 | 182.05 |
| 0 | 2 | 4 | −4 | 2 | −2 | 0 | 0 | 0 | 0 | 179.25 |
| 0 | 0 | 4 | −4 | 2 | −2 | −6 | 0 | 0 | 0 | 151.25 |
| 0 | 0 | 0 | −4 | 2 | −2 | −6 | −10 | 0 | 0 | 76.45 |
| 0 | 0 | 0 | 0 | 2 | −2 | −6 | −10 | 6 | 0 | 56.05 |
| 0 | 0 | 0 | 0 | 0 | −2 | −6 | −10 | 6 | 4 | 42.05 |
| 2 | 0 | 0 | 0 | 0 | 0 | −6 | −10 | 6 | 4 | 44.85 |
| 2 | 2 | 0 | 0 | 0 | 0 | 0 | −10 | 6 | 4 | 72.85 |
| 2 | 2 | 4 | 0 | 0 | 0 | 0 | 0 | 6 | 4 | 147.65 |
| 2 | 2 | 4 | −4 | 0 | 0 | 0 | 0 | 0 | 4 | 168.05 |

However in the following example the ‘first’ 5 parameters are used for determining the next frame value of the “first” selected parameter. In some embodiments the frame reconstructor/error determiner 756 can be configured to determine an exhaustive search procedure considering every possible value for the “first” selected parameter and calculate a distortion between the reconstructed parameter values and the original or unquantized parameter values.

For instance, where the following frame data is:

x=1.2, 3.7, 6.3, 3.1, 0.7, −2.1, −4.7, −8.4, 5.2, 0.1

which can be quantized according to the above quantization table to:

x_hat={2 4 6 4 0 −2 −4 −10 6 0}.

In this example the error value is determined using the non-quantized frame data and is the square of the earlier example.

diff=∥x-x_rec∥²

Furthermore in this example the weighting factor applied to the current stored frame data is 0.8 when applied to the previous frame when inserted into the reconstructed frame.

In this example where the ‘first’ parameter index selected is 6, and only 4 parameters are to be encoded the reconstructed values would be:

x_rec={1.6 1.6 3.2 3.2 1.6 −2 −4 −10 6 0}

and the encoding error would be ∥x-x_rec∥hu 2=18.71.

The bold values correspond to selected coded values; italic values correspond to values taken from the previous frame with the weight 0.8.

In some embodiments in addition to selecting the starting point of parameters the values kept from the previous frame can be quantized, for example using a one bit quantizer. The quantizer in some embodiments would weight the values down for example by {0.9, 0.4} depending how much the values have changed from the previous frame. In the case where there is very little change the values are weighted down less than in a case where the values have changed a lot.

In this example where the ‘first’ parameter index selected is 7, and only 4 parameters are to be encoded the reconstructed values would be:

x_rec={1.6 1.6 3.2 3.2 1.6 0 −4 −10 6 0} and the encoding error would be ∥x-x_rec∥²=23.11.

The process can continue for all the possible values of ‘first’ parameter and the one giving the lowest encoding or reconstruction error is selected and its value encoded.

In some embodiments a weighted Euclidean distance could be used as the error value to give more weight to the higher frequency bands which are more relevant for channel level differences.

The search or optimization of the value of the “first” parameter selected could be speeded up in some embodiments by searching on a sparser grid, for instance taking the values with a step of two. This is because the parameter vector is formed by interleaving values from two consecutive windows, making the values that correspond to the same sub-band to be close to one another.

Furthermore in some embodiments a generically reconstructed vector based on the last frame could be used to detect where it is better to encode the current frame values.

For example using the previous example a generically reconstructed vector would be:

x_gen={1.6 1.6 3.2 3.2 1.6 0 0 0 0 0}

which compared to

x={1.2 3.7 6.3 3.1 0.7 −2.1 −4.7 −8.4 5.2 0.1}

would give a squared difference vector of :

diff={0.16 4.41 9.61 0.01 0.81 4.41 22.09 70.56 27.04 0.01}.

In such embodiments the sum of groups of 4 consecutive components are calculated starting with ‘first’=1, up to ‘first’=10 which provides the partial sum values of

part={14.84 14.84 27.32 97.87 124.10 119.70 97.77 31.62 14.19 14.19}

which would allow the frame reconstructor/error determiner to determine that the best option is to choose is ‘first’=5, corresponding to the maximum difference of 124.10, that would be corrected if the coding starts from position 5.

These embodiments correspond to the idea of finding in the parameter vector the portion where the vector is changed the most compared to the previous frame.

In summary the algorithm for determining the ‘first’ parameter for the current frame can be as follows

1. Initialize:
Find the sub-vector starting point having the largest weighted error
Quantize the starting point of the subvector and the quantize these most important (selected) values
Set the remaining (i.e. values not quantized in previous stage) vector values to zero

2. For every consecutive frame:
Find the subvector starting point which gives the largest weighted error due to changed values compared to the previous frame
Encode the starting point and quantize the selected subvector. The selected values can be quantized as themselves or the difference to the previous values is quantized (so called safety-net switched predictive quantizer). The selection of quantization method(s) can be encoded with one or more bits.
The remaining values (i.e. values not quantized in previous stage) can be copied from the previous frame with a fixed scale or alternatively they can be scaled with multiple scales. In the latter case the optimal scale information is encoded by one or more bits.

In order to fully show the operations of the codec FIGS. 12 and 13 show a decoder and the operation of the decoder according to some embodiments. In the following example the decoder is a stereo decoder configured to receive a mono channel encoded audio signal and stereo channel extension or stereo parameters, however it would be understood that the decoder is a multichannel decoder configured to receive any number of channel encoded audio signals (downmix channels) and channel extension parameters.

In some embodiments the decoder 108 comprises a mono/downmix channel decoder 1001 (or means for decoding a downmix channel). The mono/downmix channel decoder 1001 is configured in some embodiments to receive the encoded mono/downmix channel signal.

The operation of receiving the encoded mono/downmix channel audio signal is shown in FIG. 13 by step 1101.

Furthermore the mono/downmix channel decoder 1001 can be configured to decode the encoded mono/downmix channel audio signal using the inverse process to the mono/downmix channel encoder shown in the encoder.

The operation of decoding the mono/downmix channel is shown in FIG. 13 by step 1103.

In some embodiments the decoder further is configured to output the decoded mono/downmix signal to the stereo/multichannel channel generator 1009 such that the decoded mono/downmix signal is synchronised or received substantially at the same time as the decoded stereo/multichannel parameters from the parameter set compiler 1005.

The operation of synchronising the mono/downmix to stereo/multichannel parameters is shown in FIG. 13 by step 1105.

In some embodiments the decoder 108 can comprise a stereo/multi-channel channel decoder 1003 (or means for decoding a multichannel or extension parameter). The stereo/multi-channel channel decoder 1003 is configured to receive the encoded stereo/multi-channel parameters.

The operation of receiving the encoded stereo/multi-channel parameters is shown in FIG. 13 by step 1102.

Furthermore the stereo/multi-channel channel decoder 1003 can be configured to decode the stereo/multi-channel channel signal parameters by applying the inverse processes to that applied in the encoder. For example the stereo/multi-channel channel decoder can be configured to output decoded stereo/multi-channel parameters by applying the reverse of the shift difference encoder and level difference encoder. In some embodiments the stereo/multi-channel channel decoder 1003 can be configured to receive an encoded index value indicating the ‘first’ value which can be decoded. Furthermore the stereo/multi-channel channel decoder 1003 can be configured to receive an encoded sequence mode or type value indicating the selection sequence from the ‘first’ parameter value which can be decoded and passed to the parameter set compiler.

The operation of decoding the stereo/multi-channel parameters is shown in FIG. 13 by step 1104.

The stereo/multi-channel channel decoder 1103 is further configured to output the decoded main stereo/multi-channel parameters (and in some embodiments the ‘first’ parameter value and the selection sequence indicator or mode indicator to a parameter set compiler 1005.

In some embodiments the decoder comprises a parameter set compiler 1005 (or means for compiling an extension parameter set). The parameter set compiler 1005 is configured to receive the decoded stereo/multi-channel parameters and configured to replace any previous frame (or old) stereo/multi-channel parameters with newly decoded frame parameters where replacement sub-band parameters are in the decoded frame. The location of the replacement sub-band parameters in the decoded frame can be found from the index value passed. Furthermore in some embodiments the sequence of the sub-band parameters can be found from the sequence selection values.

The operation of replacing old stereo/multi-channel parameters with decoded frame parameters where replacements occur is shown in FIG. 13 by step 1106.

The parameter set compiler 1005 thus contains a set of stereo/multi-channel parameters containing all of the sub-band stereo parameters from the most recently received frames. These parameters can be passed to the stereo/multi-channel) channel generator 1009.

The outputting a ‘complete’ set of compiled parameters is shown in FIG. 13 by step 1108.

In some embodiments the parameter set compiler 1005 can be configured to have a replacement memory period or expiry period after which the parameter set compiler 1005 discards a stored stereo/multi-channel parameter to prevent an obsolete stereo/multi-channel parameter being sent to the stereo/multi-channel channel generator 1009. Furthermore in some embodiments the parameter set compiler 1005 can be configured to weight previous parameters with a weighting factor to decrease the effect of ‘old’ data on the stereo/multichannel channel generator.

In some embodiments the decoder comprises a multichannel/stereo channel generator 1009 (or means for generating an extension channel audio signal) configured to receive the decoded stereo/multichannel (or extension) parameters and the decoded mono/downmix channel and regenerate the multichannel/stereo channels in other words applying the level differences (extension parameters) to the mono/downmix channel to generate a second (or extended) channel.

The operation of generating the stereo/multi-channel channels from the mono/downmix channel(s) and stereo/extension parameters is shown in FIG. 13 by step 1009.

Although the above examples describe embodiments of the application operating within a codec within an apparatus 10, it would be appreciated that the invention as described below may be implemented as part of any audio (or speech) codec, including any variable rate/adaptive rate audio (or speech) codec. Thus, for example, embodiments of the application may be implemented in an audio codec which may implement audio coding over fixed or wired communication paths.

Thus user equipment may comprise an audio codec such as those described in embodiments of the application above.

It shall be appreciated that the term user equipment is intended to cover any suitable type of wireless user equipment, such as mobile telephones, portable data processing devices or portable web browsers.

Furthermore elements of a public land mobile network (PLMN) may also comprise audio codecs as described above.

In general, the various embodiments of the application may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the application may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this application may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the application may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

As used in this application, the term ‘circuitry’ refers to all of the following:
(a) hardware-only circuit implementations (such as implementations in only analog and/or digital circuitry) and
(b) to combinations of circuits and software (and/or firmware), such as: (i) to a combination of processor(s) or (ii) to portions of processor(s)/software (including digital signal processor(s)), software, and memory(ies) that work together to cause an apparatus, such as a mobile phone or server, to perform various functions and
(c) to circuits, such as a microprocessor(s) or a portion of a microprocessor(s), that require software or firmware for operation, even if the software or firmware is not physically present.

This definition of ‘circuitry’ applies to all uses of this term in this application, including any claims. As a further example, as used in this application, the term ‘circuitry’ would also cover an implementation of merely a processor (or multiple processors) or portion of a processor and its (or their) accompanying software and/or firmware. The term ‘circuitry’ would also cover, for example and if applicable to the particular claim element, a baseband integrated circuit or applications processor integrated circuit for a mobile phone or similar integrated circuit in server, a cellular network device, or other network device.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-23. (canceled)

24. A method comprising:
determining for a frame of at least one audio signal a set of frame audio signal multi-channel parameters;
selecting for the frame of the at least one audio signal a sub-set of the set of frame audio signal multi-channel parameters based on an error value associated with the sub-set of the set of frame audio signal multi-channel parameters; and
generating an encoded frame audio signal multi-channel parameter based on the selected sub-set of the set of frame audio signal multi-channel parameters.

25. The method as claimed in claim 24 further comprising determining a coding bitrate for the frame of the at least one audio signal; and wherein selecting for the frame of the at least one audio signal the sub-set of the set of frame audio signal multi-channel parameters based on the error value associated with the sub-set of the set of frame audio signal multi-channel parameters comprises selecting the sub-set of the set of frame audio signal multi-channel parameters further based on the coding bitrate for the frame of the at least one audio signal.

26. The method as claimed in claim 24, wherein determining for the frame of the at least one audio signal the set of frame audio signal multi-channel parameters comprises determining a set of differences between at least two channels of the at least one audio signal, wherein the set of differences comprises two or more difference values, where each difference value is associated with a sub-division of resources defining the frame of the at least one audio signal.

27. The method as claimed in claim 26, wherein determining the set of differences between the at least two channels of the at least one audio signal comprises determining at least one of: at least one interaural time difference; and at least one interaural level difference, and wherein the sub-division of resources defining the frame of the at least one audio signal comprises at least one of: sub-band frequencies; and time periods.

28. The method as claimed in claim 24, wherein selecting for the frame of the at least one audio signal the sub-set of the set of the frame audio signal multi-channel parameters based on the error value associated with the sub-set of the set of the frame audio signal multi-channel parameters comprises:
determining at least one previous frame selected sub-set;
determining a number of elements to be selected;
generating at least two candidate sub-sets;
generating a reconstructed set from a combination of the candidate sub-set and the at least one previous frame selected sub-set;
generating an error value based on the reconstructed set and the set of frame audio signal multi-channel parameters; and
selecting one of the at least two candidate sub-sets with the smallest absolute error value.

29. The method as claimed in claim 24, further comprising:
generating for the selected sub-set at least one parameter representing the selected sub-set by at least one of generating a first parameter representing a first selected element in the selected sub-set, generating a distribution parameter representing a selection distribution of successive elements in the selected sub-set, and generating a length parameter representing the number of elements in the selected sub-set; and
generating an encoded at least one parameter representing the selected sub-set.

30. The method as claimed in claim 24, wherein generating the encoded frame audio signal multi-channel parameter based on the selected sub-set of the set of frame audio signal multi-channel parameters comprises generating codebook indices for groups of the at least one frame audio signal multi-channel parameter using vector or scalar quantization codebooks.

31. The method as claimed in claim 30, wherein generating codebook indices for the groups of the at least one frame audio signal multi-channel parameter using vector or scalar quantization codebooks comprises:
generating an encoding mapping with an associated index for the at least one frame audio signal multi-channel parameter dependent on a frequency distribution of mapping instances of the at least one frame audio signal multi-channel parameter; and
encoding the encoding mapping dependent on the associated index.

32. The method as claimed in claim 24, further comprising:
receiving at least two audio signal channels;
determining a fewer number of channels audio signal from the at least two audio signal channels and the at least one frame audio signal multi-channel parameter;
generating an encoded audio signal comprising the fewer number of channels; and
combining the encoded audio signal and the encoded at least one frame audio signal multi-channel parameter.

33. A method comprising:
receiving within a period an encoded audio signal comprising at least one frame downmix audio signal and at least one multi-channel audio signal parameter signal comprising a sub-set of a set of frame audio signal multi-channel parameters;
recovering any elements of the set of frame audio signal multi-channel parameters not present in the sub-set of the set of frame audio signal multi-channel parameters; and
generating a frame of at least two audio channels of at least one audio signal from the at least one frame downmix audio signal, and a combination of the sub-set of the set of frame audio signal multi-channel parameters and recovered elements of the set of frame audio signal multi-channel parameters not present in the sub-set of the set of frame audio signal multi-channel parameters.

34. The method as claimed in claim 33, wherein the set of frame audio signal multi-channel parameters comprises a set of differences between the at least two channels of at the least one audio signal, wherein the set of differences comprises two or more difference values, where each difference value is associated with a sub-division of resources defining the frame of the at least two channels of the at least one audio signal.

35. The method as claimed in claim 34, wherein the set of differences between the at least two channels of the at least one audio signal comprises at least one of: at least one interaural time difference; and at least one interaural level difference, and wherein the sub-division of resources defining the frame of the at least two channels of the at least one audio signal comprises at least one of: sub-band frequencies; and time periods.

36. The method as claimed in claim 33, wherein the encoded audio signal further comprises at least one parameter defining the sub-set of the set of frame audio signal multi-channel parameters; wherein recovering any elements of the set of frame audio signal multi-channel parameters not present in the sub-set of the set of frame audio signal multi-channel parameters comprises decoding the at least one parameter defining the sub-set of the set of frame audio signal multi-channel parameters to determine the sub-set elements to be recovered.

37. An apparatus comprising at least one processor and at least one memory including computer program code for one or more programs, the at least one memory and the computer program code configured to, with the at least one processor, cause the apparatus at least to:
determine for a frame of at least one audio signal a set of frame audio signal multi-channel parameters;
select for the frame of the at least one audio signal a sub-set of the set of frame audio signal multi-channel parameters based on an error value associated with the sub-set of the set of frame audio signal multi-channel parameters; and
generate an encoded frame audio signal multi-channel parameter based on the selected sub-set of the set of frame audio signal multi-channel parameters.

38. The apparatus as claimed in claim 37, wherein the apparatus is further caused to determine a coding bitrate for the frame of the at least one audio signal; and wherein the apparatus caused to select for the frame of the at least one audio signal the sub-set of the set of frame audio signal multi-channel parameters based on the error value associated with the sub-set of the set of frame audio signal multi-channel parameters is further caused to select the sub-set of the set of frame audio signal multi-channel parameters further based on the coding bitrate for the frame of the at least one audio signal.

39. The apparatus as claimed in claim 37, wherein the apparatus caused to determine for the frame of the at least one audio signal the set of frame audio signal multi-channel parameters is caused to determine a set of differences between at least two channels of the at least one audio signal, wherein the set of differences comprises two or more difference values, where each difference value is associated with a sub-division of resources defining the frame of the at least one audio signal.

40. The apparatus as claimed in claim 39, wherein the apparatus caused to determine the set of differences between the at least two channels of the at least one audio signal is caused to determine at least one of: at least one interaural time difference; and at least one interaural level difference, and wherein the sub-division of resources defining the frame of the at least one audio signal comprises at least one of: sub-band frequencies; and time periods.

41. The apparatus as claimed in claim 37, wherein the apparatus caused to select for the frame of the at least one audio signal the sub-set of the set of the frame audio signal multi-channel parameters based on the error value associated with the sub-set of the set of the frame audio signal multi-channel parameters is caused to:
determine at least one previous frame selected sub-set;
determine a number of elements to be selected;
generate at least two candidate sub-sets;
generate a reconstructed set from a combination of the candidate sub-set and the at least one previous frame selected sub-set;
generate an error value based on the reconstructed set and the set of frame audio signal multi-channel parameters; and
select one of the at least two candidate sub-sets with the smallest absolute error value.

42. The apparatus as claimed in claim 37, wherein the apparatus is further caused to:
generate for the selected sub-set at least one parameter representing the selected sub-set by at least one of generate a first parameter representing a first selected element in the selected sub-set, generate a distribution parameter representing a selection distribution of successive elements in the selected sub-set, and generate a length parameter representing the number of elements in the selected sub-set; and
generate an encoded at least one parameter representing the selected sub-set.

43. The apparatus as claimed in claim 37, wherein the apparatus caused to generate the encoded frame audio signal multi-channel parameter based on the selected sub-set of the set of frame audio signal multi-channel parameters is caused to generate codebook indices for groups of the at least one frame audio signal multi-channel parameter using vector or scalar quantization codebooks.

44. The apparatus as claimed in claim 43, wherein the apparatus caused to generate codebook indices for the groups of the at least one frame audio signal multi-channel parameter using vector or scalar quantization codebooks is caused to:
generate an encoding mapping with an associated index for the at least one frame audio signal multi-channel parameter dependent on a frequency distribution of mapping instances of the at least one frame audio signal multi-channel parameter; and
encode the encoding mapping dependent on the associated index.

45. The apparatus as claimed in claim 37, further caused to:
receive at least two audio signal channels;
determine a fewer number of channels audio signal from the at least two audio signal channels and the at least one frame audio signal multi-channel parameter;
generate an encoded audio signal comprising the fewer number of channels; and
combine the encoded audio signal and the encoded at least one frame audio signal multi-channel parameter.

46. An apparatus comprising at least one processor and at least one memory including computer program code for one or more programs, the at least one memory and the computer program code configured to, with the at least one processor, cause the apparatus at least to:
receive within a period an encoded audio signal comprising at least one frame downmix audio signal and at least one multi-channel audio signal parameter signal comprising a sub-set of a set of frame audio signal multi-channel parameters;
recover any elements of the set of frame audio signal multi-channel parameters not present in the sub-set of the set of frame audio signal multi-channel parameters; and
generate a frame of at least two audio channels of at least one audio signal from the at least one frame downmix audio signal, and a combination of the sub-set of the set of frame audio signal multi-channel parameters and recovered elements of the set of frame audio signal multi-channel parameters not present in the sub-set of the set of frame audio signal multi-channel parameters.

47. The apparatus as claimed in claim 46, wherein the set of frame audio signal multi-channel parameters comprises a set of differences between the at least two channels of at the least one audio signal, wherein the set of differences comprises two or more difference values, where each difference value is associated with a sub-division of resources defining the frame of the at least two channels of the at least one audio signal.

48. The apparatus as claimed in claim 47, wherein the set of differences between the at least two channels of the at least one audio signal comprises at least one of: at least one interaural time difference; and at least one interaural level difference, and wherein the sub-division of resources defining the frame of the at least two channels of the at least one audio signal comprises at least one of: sub-band frequencies; and time periods.

49. The apparatus as claimed in claim 46, wherein the encoded audio signal further comprises at least one parameter defining the sub-set of the set of frame audio signal multi-channel parameters; wherein the apparatus caused to recover any elements of the set of frame audio signal multi-channel parameters not present in the sub-set of the set of frame audio signal multi-channel parameters is caused to decode the at least one parameter defining the sub-set of the set of frame audio signal multi-channel parameters to determine the sub-set elements to be recovered.
